(19) United States
(12) Patent Application Publication
(10) Pub. No.: US 2026/0184087 A1
(43) Pub. Date: Jul. 2, 2026

(54) Ink Jet Recording Method

(71) Applicant: SEIKO EPSON CORPORATION, Tokyo (JP)

(72) Inventors: Kazuto AOKI, Shiojiri (JP); Naoki YOKOYAMA, Shiojiri (JP); Akiko YAMADA, Shiojiri (JP)

(21) Appl. No.: 19/430,617

(22) Filed: Dec. 23, 2025

(30) Foreign Application Priority Data
Dec. 26, 2024 (JP) 2024-231052

(51) Int. Cl. B41J 11/00; B41J 2/21; B41J 3/407; C09D 11/322; C09D 11/54; D06P 5/30

(52) U.S. Cl. CPC B41J 11/002; B41J 2/2114; B41J 3/4078; C09D 11/322; C09D 11/54; D06P 5/30

(57) ABSTRACT

An ink jet recording method according to an embodiment of the present disclosure includes an acidic reactive liquid application step of applying an acidic reactive liquid containing an acid and water to a fabric using an ink jet method, an anionic clear ink application step of applying an anionic clear ink composition containing a first anionic resin particle and water to the fabric using the ink jet method, an anionic colored ink application step of applying an anionic colored ink composition containing a pigment, a second anionic resin particle, and water to a region to which the clear ink composition is applied, using the ink jet method, and an anionic solution application step of applying an anionic aqueous alkaline solution having a pH greater than 8.0 to a region to which the colored ink composition is applied.

The present application is based on, and claims priority from JP Application Serial Number 2024-231052, filed Dec. 26, 2024, the disclosure of which is hereby incorporated by reference herein in its entirety.

### BACKGROUND

### 1. Technical Field

The present disclosure relates to an ink jet recording method.

2. Related Art

In the related art, a technology for treating a fabric with a reactive liquid containing an agglomerating agent for agglomerating a component in an ink to improve a color developing property and the like of a recorded matter in textile printing using an ink jet ink composition is known.

For example, JP-T-2022-548985 discloses an ink jet printing method for printing on a base material of a fiber product, including applying a pre-treatment composition, applying a clear ink, and applying a white ink.

However, an issue arises in achieving compatibility between reduction of image cracking and reduction of ink bleeding.

### SUMMARY

According to an aspect of the present disclosure, there is provided an ink jet recording method including an acidic reactive liquid application step of applying an acidic reactive liquid containing an acid and water to a fabric using an ink jet method, an anionic clear ink application step of applying an anionic clear ink composition containing a first anionic resin particle and water to the fabric using the ink jet method, an anionic colored ink application step of applying an anionic colored ink composition containing a pigment, a second anionic resin particle, and water to a region to which the clear ink composition is applied, using the ink jet method, and an anionic solution application step of applying an anionic aqueous alkaline solution having a pH greater than 8.0 to a region to which the colored ink composition is applied.

### BRIEF DESCRIPTION OF THE DRAWINGS

FIG. 1 is a perspective view of a serial printer.

FIG. 2 is a schematic diagram showing an example of nozzle array disposition of an ink jet head.

FIG. 3 is a schematic side view of a line printer.

FIG. 4 shows Table 1 showing composition examples of each composition.

FIG. 5 shows Table 2 showing conditions and evaluation results of each example.

FIG. 6 shows Table 3 showing conditions and evaluation results of each example and each comparative example.

### DESCRIPTION OF EMBODIMENTS

Hereinafter, an embodiment of the present disclosure will be described. The embodiment set forth below describes an example of the present disclosure. The present disclosure is not limited to the following embodiment and includes various modifications implemented without changing the gist of the present disclosure. Not all of the configurations described below are configurations essential to the present disclosure.

In the present specification, a numerical value range represented using “to” means a range including numerical values shown before and after “to” as a lower limit value and an upper limit value.

In the present specification, the “ink jet method” means a method of ejecting a droplet of a composition for ink jet from a nozzle of an ink jet head to apply the droplet to a recording medium.

In the present specification, “(meth)acrylic” means acrylic or methacrylic, and “(meth)acrylate” means acrylate or methacrylate.

### 1. Ink Jet Recording Method

An ink jet recording method according to an embodiment of the present disclosure includes an acidic reactive liquid application step of applying an acidic reactive liquid containing an acid and water to a fabric using an ink jet method, an anionic clear ink application step of applying an anionic clear ink composition containing a first anionic resin particle and water to the fabric using the ink jet method, an anionic colored ink application step of applying an anionic colored ink composition containing a pigment, a second anionic resin particle, and water to a region to which the clear ink composition is applied, using the ink jet method, and an anionic solution application step of applying an anionic aqueous alkaline solution having a pH greater than 8.0 to a region to which the colored ink composition is applied.

When a colored ink applied to a fabric permeates through the fabric, a color developing property decreases. Therefore, it is conceivable to form a layer of a clear ink near a surface of the fabric by agglomerating a component (for example, an anionic resin particle) in an anionic clear ink using an acidic reactive liquid. Since the layer of the clear ink is near the surface of the fabric, the layer of the clear ink functions as a base for a resin layer, and permeation of the colored ink applied to the layer of the clear ink into the fabric is reduced. Thus, a recorded matter having a favorable color developing property can be obtained.

Here, the acidic reactive liquid has relatively high component volatility and thus is less likely to remain on the fabric (compared to a polyvalent metal salt or the like used as an agglomerating agent), and the fabric is less likely to discolor during drying.

Meanwhile, when the acidic reactive liquid is used, a coating of the recorded matter may crack after drying. This is because excessive agglomeration proceeds because of the acid not neutralized by an anionic component in the ink. In particular, when there are a plurality of types of ink to be agglomerated, and a large amount of the acidic reactive liquid needs to be applied, the coating is likely to crack more noticeably.

When a sufficient amount of the reactive liquid is not applied, excessive agglomeration is less likely to proceed, and the coating is less likely to crack. Meanwhile, a sufficient ink agglomeration effect may not be achieved, and ink bleeding may occur.

Meanwhile, according to the ink jet recording method according to the present embodiment, an excessive acid can be neutralized by applying an anionic aqueous alkaline solution having a pH greater than 8.0 to the region to which the colored ink is applied. Accordingly, excessive agglomeration during drying can be reduced, and cracking of the coating can be reduced. In addition, in such a method, a sufficient amount of the reactive liquid is applied. Thus, ink bleeding can also be reduced.

Hereinafter, each step of the ink jet recording method according to the present embodiment will be described.

### 1.1 Acidic Reactive Liquid Application Step

The ink jet recording method according to the present embodiment includes the acidic reactive liquid application step of applying the acidic reactive liquid containing the acid and the water to the fabric using the ink jet method.

### 1.1.1 Aspect of Application

### 1.1.1.1 Application Amount

An application amount (X) of the reactive liquid per unit area of the fabric in the acidic reactive liquid application step is not particularly limited and is preferably 0.010 g/inch² or more, more preferably 0.020 g/inch² or more, further preferably 0.030 g/inch² or more, still more preferably 0.040 g/inch² or more, particularly preferably 0.045 g/inch² or more, and more particularly preferably 0.050 g/inch² or more. The application amount (X) of the reactive liquid per unit area of the fabric is preferably 0.100 g/inch² or less, more preferably 0.080 g/inch² or less, further preferably 0.070 g/inch² or less, particularly preferably 0.060 g/inch² or less, and more particularly preferably 0.055 g/inch² or less.

When the application amount of the reactive liquid is 0.010 g/inch² or more, ink bleeding tends to be further reduced. When the application amount of the reactive liquid is 0.100 g/inch² or less, image cracking tends to be further reduced.

The application amount (X) of the reactive liquid applied to the fabric per unit area in the acidic reactive liquid application step, a neutralizing power conversion value (Y) of the clear ink composition applied to the fabric for the reactive liquid in the anionic clear ink application step, and a neutralizing power conversion value (Z) of the colored ink composition applied to the fabric for the reactive liquid in the anionic colored ink application step preferably satisfy the following relational expression.

$$X - ( Y + Z ) \geq 0 \qquad Expression ( 1 )$$

The “neutralizing power conversion value (Y)” is calculated using the following procedure.

The reactive liquid is dropped to 50 g of the clear ink composition, and a dropped weight (NW_{c}) of the reactive liquid when a pH of a liquid mixture of the clear ink composition and the reactive liquid reaches 7.0 is measured. A value obtained by dividing NW_{c} by a weight (50 [g]) of the clear ink composition is used as a neutralized weight ratio (NR_{c} [−]) of the clear ink composition. A value obtained by multiplying an application amount (V_{c} [g/inch²]) of the clear ink composition per unit area by NR_{c} is used as the neutralizing power conversion value (Y) of the clear ink composition for the reactive liquid.

$${NR}_{c} = {NW}_{c} / 50$$

$$Y = {V}_{c} \times N {R}_{c}$$

The “neutralizing power conversion value (Z)” is calculated using the following procedure.

The reactive liquid is dropped to 50 g of the colored ink composition, and a dropped weight (NW_{w}) of the reactive liquid when a pH of a liquid mixture of the colored ink composition and the reactive liquid reaches 7.0 is measured. A value obtained by dividing NW_{w} by a weight (50 [g]) of the colored ink composition is used as a neutralized weight ratio (NR_{w} [−]) of the colored ink composition. A value obtained by multiplying an application amount (V_{w} [g/inch²]) of the colored ink composition per unit area by NR_{w} is used as the neutralizing power conversion value (Z) of the colored ink composition for the reactive liquid.

$${NR}_{w} = {NW}_{w} / 50$$

$$Z = {V}_{w} \times {NR}_{w}$$

When Expression (1) is satisfied, a sufficient amount of the reactive liquid is applied in the acidic reactive liquid application step. Ink bleeding tends to be further reduced, and a more favorable color developing property tends to be achieved.

A value of “X−(Y+Z)” in Expression (1) is 0 or more and is more preferably 0.001 or more, further preferably 0.002 or more, still more preferably 0.003 or more, and particularly preferably 0.004 or more. The value of “X−(Y+Z)” in Expression (1) is preferably 0.010 or less, more preferably 0.008 or less, and further preferably 0.006 or less.

When the value of “X−(Y+Z)” in Expression (1) is 0.010 or less, image cracking tends to be reduced.

The X, the Y, the Z, and a neutralizing power conversion value (W) of the aqueous alkaline solution applied to the region to which the colored ink composition is applied, for the reactive liquid in the anionic solution application step preferably satisfy the following relational expression.

$$W \geq X - ( Y + Z ) \qquad Expression ( 2 )$$

The “neutralizing power conversion value (W)” is calculated using the following procedure.

The reactive liquid is dropped to 50 g of the aqueous alkaline solution, and a dropped weight (NWₙ) of the reactive liquid when a pH of a liquid mixture of the aqueous alkaline solution and the reactive liquid reaches 7.0 is measured. A value obtained by dividing NWₙ by a weight (50 [g]) of the aqueous alkaline solution is used as a neutralized weight ratio (NRₙ [−]) of the aqueous alkaline solution. A value obtained by multiplying an application amount (Vₙ [g/inch²]) of the aqueous alkaline solution per unit area by NRₙ is used as the neutralizing power conversion value (W) of the aqueous alkaline solution for the reactive liquid.

$${NR}_{n} = {NW}_{n} / 50$$

$$W = {V}_{n} \times {NR}_{n}$$

When Expression (2) is satisfied, the excessive acid applied in the acidic reactive liquid application step can be sufficiently neutralized, and image cracking tends to be further reduced.

A value of “W−(X−(Y+Z))” in Expression (2) is 0 or more and is more preferably 0.001 or more, further preferably 0.003 or more, still more preferably 0.005 or more, and particularly preferably 0.007 or more. The value of “W−(X−(Y+Z))” in Expression (2) is preferably 0.015 or less, more preferably 0.012 or less, and further preferably 0.010 or less.

### 1.1.1.2 Order of Application

In the ink jet recording method according to the present embodiment, an order in which the acidic reactive liquid application step is performed is not particularly limited. For example, the acidic reactive liquid application step may be performed before, after, or at the same time as applying the ink, that is, the anionic clear ink application step or the anionic colored ink application step. The acidic reactive liquid application step may be performed a plurality of times.

In the ink jet recording method according to the present embodiment, the acidic reactive liquid application step and the anionic clear ink application step are preferably performed by applying the reactive liquid and the clear ink composition to the same region on the fabric in the same scanning.

Accordingly, the reactive liquid and the clear ink composition can be applied at the same time using the ink jet method. The resin layer can be formed near the surface of the fabric, and the color developing property tends to further improve.

In the ink jet recording method according to the present embodiment, it is also preferable that the acidic reactive liquid application step and the anionic colored ink application step are performed by applying the reactive liquid and the colored ink composition to the same region on the fabric in the same scanning.

Accordingly, the reactive liquid and the colored ink composition can be applied at the same time using the ink jet method. Both liquids are likely to mix with each other, and an agglomeration reaction of a colored ink component effectively occurs. The color developing property tends to further improve.

Here, “scanning” means moving the ink jet head relative to a recording region on the fabric. In this case, scanning may be performed by moving the ink jet head with respect to the fabric or by moving the fabric with respect to the ink jet head. Alternatively, a relative positional relationship between both of the ink jet head and the fabric may be changed by moving positions of both of the ink jet head and the fabric.

The ink jet head can be mounted on, for example, a carriage. The ink jet head may be moved by moving the carriage. That is, even in this case, the ink jet head moves.

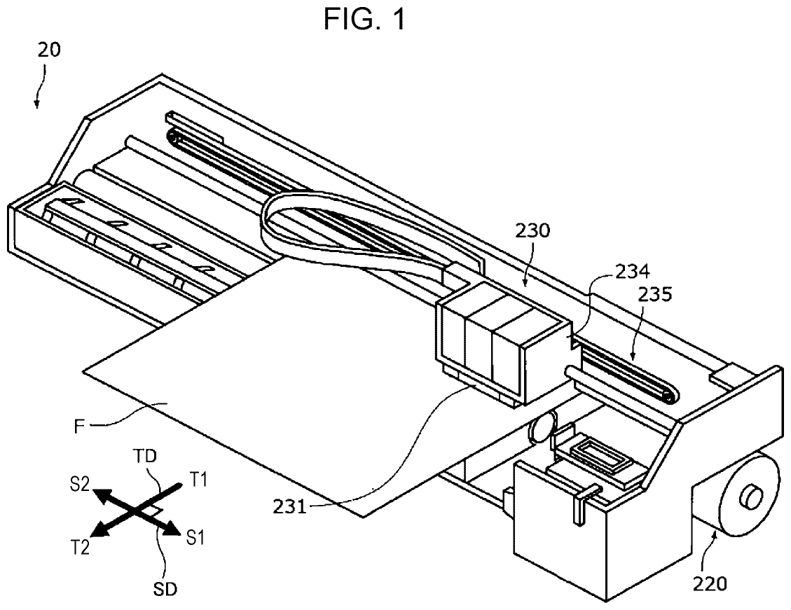

Accordingly, for example, in an ink jet recording apparatus 20 of a serial type shown in FIG. 1, “scanning” is performed by performing recording while moving a carriage 234 including an ink jet head 231 in a scanning direction SD intersecting with a transport direction TD of a recording medium F.

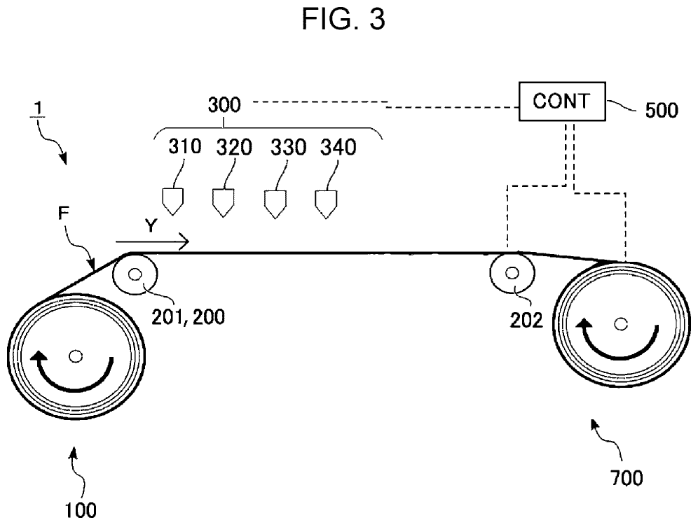

For example, in an ink jet recording apparatus 1 of a line type shown in FIG. 3, “scanning” is performed by performing recording while moving a position of the recording medium F relative to a line head 300 having a length corresponding to a width of the recording medium F, in a direction intersecting with a direction of the width. In recording of the line type, the ink jet head (line head) does not move and is fixed during recording, and recording is performed in a single scanning.

The “length corresponding to the width of the recording medium” is not limited to a length when the width of the recording medium and the length (width) of the line head completely match, and may be a length greater than or equal to the length corresponding to the width of the recording medium or a length corresponding to a width (recording width) of the recording medium in which the ink is to be ejected (an image is to be recorded).

A difference in time between application of the reactive liquid and application of the clear ink composition in the same region of the fabric is preferably within 30 seconds, more preferably within 15 seconds, further preferably within 5 seconds, still more preferably within 1 second, particularly preferably within 0.5 seconds, and more particularly preferably within 0.1 seconds. When the difference in time is within this range, the resin layer is formed near the surface of the fabric, and the color developing property tends to further improve.

From a viewpoint of a tendency for the color developing property to further improve, it is preferable that a difference in time between application of the reactive liquid and application of the colored ink composition in the same region of the fabric is also set as described above.

### 1.1.2 Reactive Liquid

The reactive liquid used in the acidic reactive liquid application step included in the ink jet recording method according to the present embodiment is an acidic reactive liquid containing an acid and water. Hereinafter, each component contained in the reactive liquid will be described.

### 1.1.2.1 Acid

The reactive liquid contains an acid and is acidic. The reactive liquid being “acidic” means having a pH less than 7.

Examples of the acid include an inorganic acid such as sulfuric acid, hydrochloric acid, and nitric acid, and an organic acid.

Preferred examples of the organic acid include poly(meth)acrylic acid, formic acid, acetic acid, propionic acid, glycolic acid, oxalic acid, malonic acid, malic acid, maleic acid, ascorbic acid, succinic acid, glutaric acid, adipic acid, fumaric acid, citric acid, tartaric acid, lactic acid, pyruvic acid, pyrrolidone carboxylic acid, pyrone carboxylic acid, pyrrole carboxylic acid, furan carboxylic acid, pyridine carboxylic acid, coumalic acid, thiophene carboxylic acid, nicotinic acid, derivatives of these compounds, or salts thereof.

The acid is preferably an organic acid and more preferably a compound including one to three carboxyl groups. In particular, when the acid is a compound including one to three carboxyl groups, proper agglomeration ability of the ink component is achieved, and both of reduction of image cracking and reduction of ink bleeding tend to be favorably achieved.

Examples of the compound including one carboxyl group include poly(meth)acrylic acid, formic acid, acetic acid, propionic acid, glycolic acid, lactic acid, pyruvic acid, pyrrolidone carboxylic acid, pyrone carboxylic acid, pyrrole carboxylic acid, furan carboxylic acid, pyridine carboxylic acid, coumalic acid, thiophene carboxylic acid, and nicotinic acid, and the compound is more preferably lactic acid.

Examples of the compound including two carboxyl groups include oxalic acid, malonic acid, malic acid, maleic acid, succinic acid, glutaric acid, adipic acid, fumaric acid, and tartaric acid, and the compound is more preferably succinic acid.

Examples of the compound including three carboxyl groups include citric acid and isocitric acid, and the compound is more preferably citric acid.

The compound including one to three carboxyl groups is preferably one or more selected from lactic acid, succinic acid, and citric acid among the examples.

From a viewpoint of further enhancing the color developing property and reduction of ink bleeding, a content of the acid is preferably 0.5% by mass or more, more preferably 1.0% by mass or more, further preferably 2.0% by mass or more, and particularly preferably 3.0% by mass or more with respect to a total amount of the reactive liquid.

From a viewpoint of further enhancing reduction of image cracking, the content of the acid is preferably 20% by mass or less, more preferably 15% by mass or less, further preferably 10% by mass or less, and particularly preferably 8% by mass or less with respect to the total amount of the reactive liquid.

### 1.1.2.2 Water

The reactive liquid contains the water. Examples of the water include pure water such as ion-exchanged water, ultrafiltered water, reverse osmosis water, and distilled water, and water having reduced ionic impurities, such as ultrapure water. When water sterilized through ultraviolet irradiation, addition of hydrogen peroxide, or the like is used, generation of bacterium or fungi when the reactive liquid is stored for a long term can be reduced.

A content of the water is preferably 40% by mass or more, further preferably 45% by mass or more, more preferably 50% by mass or more, and particularly preferably 60% by mass or more with respect to the total amount of the reactive liquid. An upper limit of the content of the water is not particularly limited and, for example, preferably 90% by mass or less, further preferably 85% by mass or less, and more preferably 80% by mass or less with respect to the total amount of the reactive liquid.

### 1.1.2.3 Organic Solvent

The reactive liquid may contain an organic solvent. Examples of the organic solvent include esters, glycol ethers, cyclic esters, amides, alcohols, and polyhydric alcohols.

Examples of the esters include glycol monoacetates such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxybutyl acetate, and glycol diesters such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, propylene glycol acetate propionate, propylene glycol acetate butyrate, dipropylene glycol acetate butyrate, and dipropylene glycol acetate propionate.

Examples of the glycol ethers include monoether or diether of alkylene glycol.

Examples of the monoether of alkylene glycol include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, tripropylene glycol monobutyl ether, 3-methoxy-3-methylbutanol, and 3-methoxy-butanol.

Examples of the diether of alkylene glycol include alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Examples of the cyclic esters include cyclic esters (lactones) such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, and ε-decanolactone, and compounds thereof in which hydrogen of a methylene group adjacent to a carbonyl group is substituted with an alkyl group having a carbon number of 1 to 4.

Examples of the amides include cyclic amides and acyclic amides. Examples of the acyclic amides include alkoxyalkylamides.

Examples of the cyclic amides include lactams. Examples of the lactams include pyrrolidones such as 2-pyrrolidone, 1-methyl-2-pyrrolidone, 1-ethyl-2-pyrrolidone, 1-propyl-2-pyrrolidone, 1-butyl-2-pyrrolidone, and 1-(2-hydroxyethyl)pyrrolidin-2-one.

Examples of the alkoxyalkylamides include 3-methoxy-N, N-dimethylpropionamide, 3-methoxy-N, N-diethylpropionamide, 3-methoxy-N, N-methylethylpropionamide, 3-ethoxy-N, N-dimethylpropionamide, 3-ethoxy-N, N-diethylpropionamide, 3-ethoxy-N, N-methylethylpropionamide, 3-n-butoxy-N, N-dimethylpropionamide, 3-n-butoxy-N, N-diethylpropionamide, 3-n-butoxy-N, N-methylethylpropionamide, 3-n-propoxy-N, N-dimethylpropionamide, 3-n-propoxy-N, N-diethylpropionamide, 3-n-propoxy-N, N-methylethylpropionamide, 3-iso-propoxy-N, N-dimethylpropionamide, 3-iso-propoxy-N, N-diethylpropionamide, 3-iso-propoxy-N, N-methylethylpropionamide, 3-tert-butoxy-N, N-dimethylpropionamide, 3-tert-butoxy-N, N-diethylpropionamide, 3-tert-butoxy-N, N-methylethylpropionamide, and N, N-dimethylisobutyrate amide.

Examples of the alcohols include a compound in which one hydrogen atom of alkane is substituted with a hydroxyl group. A carbon number of the alkane is preferably 10 or less, more preferably 6 or less, and further preferably 3 or less. The carbon number of the alkane is 1 or more and preferably 2 or more. The alkane may be of a linear type or a branched type. Examples of the alcohols include methanol, ethanol, n-propyl alcohol, iso-propyl alcohol, n-butanol, 2-butanol, tert-butanol, iso-butanol, n-pentanol, 2-pentanol, 3-pentanol, tert-pentanol, 2-phenoxy ethanol, benzyl alcohol, and phenoxy propanol.

The polyhydric alcohols have two or more hydroxyl groups in their molecules. Examples of the polyhydric alcohols include alkanediols and polyols.

The polyhydric alcohols may have a carbon-hydrogen skeleton and two or more hydroxyl groups in their molecules and have an ether-bonded oxygen atom. Structures other than these structures are preferably not included.

Examples of the alkanediols include a compound in which the alkane is substituted with two hydroxyl groups. Examples of the alkanediols include 1,2-alkanediol, which is a general term for compounds in which hydroxyl groups are substituted at the first and second positions of the alkane, and other alkanediols other than the 1,2-alkanediol. The 1,2-alkanediol is preferably used.

Carbon numbers of the alkanediols are preferably 2 or more and more preferably 3 to 10. The carbon numbers are preferably 5 or more and more preferably 5 to 8. Meanwhile, the carbon numbers are also preferably 4 or less.

Examples of the 1,2-alkanediol include ethylene glycol, 1,2-propanediol (propylene glycol), 1,2-butanediol, 1,2-pentanediol (1,2PD), 1,2-hexanediol, 1,2-heptanediol, 1,2-octanediol, 1,2-nonanediol, 1,2-decanediol, 3-methyl-1,2-butanediol, 3-methyl-1,2-pentanediol, 4-methyl-1,2-pentanediol, 3,4-dimethyl-1,2-pentanediol, 3-ethyl-1,2-pentanediol, 4-ethyl-1,2-pentanediol, 3-methyl-1,2-hexanediol, 4-methyl-1,2-hexanediol, 5-methyl-1,2-hexanediol, 3,4-dimethyl-1,2-hexanediol, 3,5-dimethyl-1,2-hexanediol, 4,5-dimethyl-1,2-hexanediol, 3-ethyl-1,2-hexanediol, 4-ethyl-1,2-hexanediol, and 3-ethyl-4-methyl-1,2-hexanediol.

Examples of the other alkanediols include 1,3-propanediol, 1,3-butylene glycol (also known as 1,3-butanediol), 1,4-butanediol, 2,3-butanediol, 1,5-pentanediol, 2,4-pentanediol, 2-methyl-1,3-propanediol, 3-methyl-1,3-butanediol, 3-methyl-1,5-pentanediol, 2-ethyl-1,3-hexanediol, 2-methyl-1,3-pentanediol, 3-methyl-1,5-pentanediol, 2-methylpentane-2,4-diol, 1,6-hexanediol, 2-ethyl-2-methyl-1,3-propanediol, and 2-methyl-2-propyl-1,3-propanediol.

Examples of the polyols include a condensate in which two or more molecules of the alkanediols are intermolecularly condensed between hydroxyl groups, and a compound including three or more hydroxyl groups.

Examples of the condensate in which two or more molecules of the alkanediols are intermolecularly condensed between hydroxyl groups include dialkylene glycol such as diethylene glycol and dipropylene glycol, and trialkylene glycol such as triethylene glycol and tripropylene glycol.

The compound including three or more hydroxyl groups is a compound including three or more hydroxyl groups having an alkane or polyether structure as a skeleton. Examples of the compound including three or more hydroxyl groups include glycerin, trimethylolethane, trimethylolpropane, 1,2,5-hexanetriol, 1,2,6-hexanetriol, pentaerythritol, and polyoxypropylenetriol.

One type of the organic solvent may be used alone, or two or more types of the organic solvent may be used in combination.

The organic solvent preferably includes alkanediols, more preferably includes 1,2-alkanediol, and particularly preferably includes propylene glycol among the examples. When the organic solvent includes these solvents, reduction of image cracking and reduction of ink bleeding may be further enhanced.

A content of the organic solvent is preferably 5% to 50% by mass, more preferably 10% to 40% by mass, further preferably 15% to 35% by mass, and particularly preferably 20% to 30% by mass with respect to the total amount of the reactive liquid. When the content of the organic solvent is within this range, reduction of image cracking and reduction of ink bleeding may be further enhanced.

### 1.1.2.4 Surfactant

The reactive liquid may contain a surfactant. The surfactant can be used to reduce surface tension of the reactive liquid, for example, to adjust and improve permeability of the fabric. As the surfactant, any of a nonionic surfactant, an anionic surfactant, a cationic surfactant, and an amphoteric surfactant can be used, and these may also be used in combination. Among these surfactants, an acetylene-based surfactant (acetylene glycol-based surfactant), a silicon-based surfactant, and a fluorine-based surfactant can be more preferably used, and the acetylene-based surfactant can be further preferably used.

The acetylene glycol-based surfactant is not particularly limited and is, for example, preferably one or more selected from an alkylene oxide adduct of 2,4,7,9-tetramethyl-5-decyne-4,7-diol and 2,4,7,9-tetramethyl-5-decyne-4,7-diol, and an alkylene oxide adduct of 2,4-dimethyl-5-decyne-4-ol and 2,4-dimethyl-5-decyne-4-ol. A commercially available product of the acetylene glycol-based surfactant is not particularly limited. Examples thereof include Surfinol 104, 104E, 104H, 104A, 104BC, 104DPM, 104PA, 104PG-50, 104S, 420, 440, 465, 485, SE, SE-F, 504,61, DF37, CT111, CT121, CT131, CT136, TG, GA, DF110D (all product names, manufactured by Air Products Japan Inc.), OLFINE B, Y, P, A, STG, SPC, E1004, E1010, PD-001, PD-002W, PD-003, PD-004, EXP. 4001, EXP. 4036, EXP. 4051, AF-103,AF-104, AK-02, SK-14, AE-3 (all product names, manufactured by Nissin Chemical Industry Co., Ltd.), and acetylenol E00,E00P, E40, E100 (all product names, manufactured by Kawaken Fine Chemicals Co., Ltd.). One type of the acetylene glycol-based surfactant may be used alone, or two or more types of the acetylene glycol-based surfactant may be used in combination.

The silicone-based surfactant is not particularly limited. Examples thereof include a polysiloxane-based compound and polyether-modified organosiloxane. A commercially available product of the silicone-based surfactant is not particularly limited. Examples thereof include BYK-306, BYK-307, BYK-333, BYK-341, BYK-345,BYK-346, BYK-348, and BYK-349 (product names, manufactured by BYK Chemie Japan Co., Ltd.), KF-351A, KF-352A, KF-353,KF-354L, KF-355A, KF-615A, KF-945, KF-640, KF-642, KF-643,KF-6020, X-22-4515, KF-6011, KF-6012, KF-6015, and KF-6017(product names, manufactured by Shin-Etsu Chemical Co., Ltd.), and Silface SAG503A and Silface SAG014 (product names, manufactured by Nissin Chemical Industry Co., Ltd.). One type of the silicone-based surfactant may be used alone, or two or more types of the silicone-based surfactant may be used in combination.

The fluorine-based surfactant is not particularly limited. Examples thereof include perfluoroalkyl sulfonate, perfluoroalkyl carboxylate, perfluoroalkyl phosphate, a perfluoroalkyl ethylene oxide adduct, perfluoroalkyl betaine, and a perfluoroalkylamine oxide compound. A commercially available product of the fluorine-based surfactant is not particularly limited. Examples thereof include S-144 and S-145 (product names, manufactured by AGC Inc.); FC-170C, FC-430, Fluorad-FC4430 (product names, manufactured by Sumitomo 3M Co., Ltd.); FSO, FSO-100, FSN, FSN-100, and FS-300 (product names, manufactured by Dupont); and FT-250 and 251 (product names, manufactured by Neos Co., Ltd.). One type of the fluorine-based surfactant may be used alone, or two or more types of the fluorine-based surfactant may be used in combination.

One type of the surfactant may be used alone, or two or more types of the surfactant may be used in combination.

A content of the surfactant is preferably 5.0% by mass or less, more preferably 3.0% by mass or less, further preferably 2.0% by mass or less, particularly preferably 1.5% by mass or less, and more particularly preferably 1.0% by mass or less with respect to the total amount of the reactive liquid. When the content of the surfactant is within this range, in particular, 2.0% by mass or less, viscosity of the liquid mixture when the reactive liquid and the clear ink mix with each other is likely to increase. The resin layer is more favorably formed near the surface of the fabric, and this contributes to exhibiting a sealing effect. The color developing property and reduction of ink bleeding tend to be further enhanced.

A lower limit of the content of the surfactant is not particularly limited and is preferably 0.1% by mass or more, further preferably 0.3% by mass or more, and more preferably 0.5% by mass or more with respect to the total amount of the reactive liquid.

### 1.1.2.5 Other Components

The reactive liquid may contain various additives such as a pH adjuster, a preservative or a fungicide, a rust inhibitor, a chelator, a viscosity adjuster, a dissolution aid, and an antioxidant, as necessary. A content of such an additive when contained is preferably 0.05% to 5% by mass, more preferably 0.1% to 3% by mass, and further preferably 0.1% to 1% by mass with respect to the total amount of the reactive liquid.

The reactive liquid may contain a coloring material such as a pigment. A content of the coloring material is preferably 0.2% by mass or less, more preferably 0.1% by mass or less, and further preferably 0.05% by mass or less with respect to the total amount of the reactive liquid, and a lower limit of the content is 0% by mass. The reactive liquid preferably does not contain the coloring material.

### 1.1.2.6 Physical Property

The pH of the reactive liquid is not particularly limited as long as being acidic and is preferably 6 or less, more preferably 5 or less, further preferably 4 or less, and particularly preferably 3 or less.

Viscosity of the reactive liquid is preferably 1.0 to 10 mPa·s, more preferably 3.5 to 8.0 mPa·s, and further preferably 2.0 to 4.0 mPa·s at 20° C. In particular, when the viscosity is 3.0 mPa·s or more, a more favorable color developing property tends to be achieved. When the viscosity is 8.0 mPa·s or less, more favorable stability of ejection tends to be achieved. For example, the viscosity can be measured using a viscoelasticity tester MCR-300 (product name) manufactured by Pysica.

The surface tension of the reactive liquid is preferably 25 to 40 mN/m, more preferably 25 to 35 mN/m, further preferably 27 to 35 mN/m, and particularly preferably 30 to 33 mN/m. For example, the surface tension can be measured based on a Wilhelmy method using a surface tensiometer (DY-300 manufactured by Kyowa Interface Science Co., Ltd.). The surface tension is preferably a measurement value at 20° C.

### 1.1.3 Fabric

Examples of a material of the fabric used in the ink jet recording method according to the present embodiment include a natural fiber such as cotton, hemp, wool, and silk, a synthetic fiber such as polypropylene, polyester, acetate, triacetate, polyamide, and polyurethane, and a biodegradable fiber such as polylactic acid, and a blended fiber thereof may also be used. Among these materials, cotton, polyester, or a blend of cotton and polyester is readily available as the fabric, which is preferable.

Examples of a form of the fabric include a cloth, clothes, and other accessories. The cloth includes a woven fabric, a knitted fabric, a nonwoven fabric, and the like. The clothes and other accessories include a T-shirt, a handkerchief, a scarf, a towel, and a handbag after sewing, types of furniture such as a bag, a curtain, a sheet, a bedspread, and a wallpaper made of cloth, and a cloth before and after cutting as a part before sewing. Examples of these forms include a long roll-shaped form, a form cut in a predetermined size, and a form having a shape of a product.

A value of lightness L^{*} of the fabric in the L^{*}a^{*}b^{*} color space is preferably 70 or less. The value of L^{*} may be 60 or less or 50 or less. In recording on such a fabric, a white ink (a base) may be used as the colored ink composition to obtain an enhanced color developing property. The white ink contains a relatively large amount of a coloring material, and an application amount of the white ink is also relatively large. Thus, a large amount of the reactive liquid needs to be applied, and image cracking tends to occur more easily. Meanwhile, according to the ink jet recording method according to the present embodiment, even when such a fabric is used, image cracking tends to be favorably reduced.

The value of L^{*} can be measured using a well-known colorimeter. For example, the value of L^{*} can be measured using Spectrolino (manufactured by GretagMacbeth).

Examples of the fabric of which the value of L^{*} is 70 or less include a colored fabric colored in advance with a dye or the like, and a black fabric is preferably used. Examples of the dye with which the fabric is colored in advance include a water-soluble dye such as an acidic dye and a basic dye, a disperse dye used in combination with a dispersant (a surfactant), and a reactive dye. As a method of coloring the fabric with the dye, a well-known method can be adopted depending on the material forming the fabric and the form and the like of the fabric.

### 1.2 Anionic Clear Ink Application Step

The ink jet recording method according to the present embodiment includes the anionic clear ink application step of applying the anionic clear ink composition containing the first anionic resin particle and the water to the fabric using the ink jet method.

### 1.2.1 Aspect of Application

### 1.2.1.1 Application Amount

The application amount (V_{c}) of the clear ink composition per unit area of the fabric in the anionic clear ink application step is not particularly limited and is preferably 0.010 g/inch² or more, more preferably 0.030 g/inch² or more, further preferably 0.050 g/inch² or more, still more preferably 0.070 g/inch² or more, and particularly preferably 0.100 g/inch² or more. The application amount (V_{c}) of the clear ink composition per unit area of the fabric is preferably 0.200 g/inch² or less, more preferably 0.150 g/inch² or less, and further preferably 0.120 g/inch² or less.

When the application amount of the clear ink composition is 0.010 g/inch² or more, a more favorable color developing property tends to be achieved. When the application amount of the clear ink composition is 0.200 g/inch² or less, image cracking tends to be further reduced.

### 1.2.1.2 Order of Application

In the ink jet recording method according to the present embodiment, an order in which the anionic clear ink application step is performed is not particularly limited as long as having an aspect in which the colored ink composition can be applied to the region to which the clear ink composition is applied in the anionic colored ink application step described later. For example, the anionic clear ink application step may be performed before or at the same time as the anionic colored ink application step. However, when the anionic clear ink application step is performed at the same time as the anionic colored ink application step, this results in an aspect in which the clear ink composition is applied to the fabric first, and then the colored ink composition is applied to the fabric.

By applying the clear ink composition and the colored ink composition to the same region of the fabric in the same scanning, the anionic clear ink application step and the anionic colored ink application step can be performed at the same time. However, as an order of landing on the fabric, the clear ink composition needs to be applied first, and then the colored ink composition needs to be applied.

A difference in time between application of the clear ink composition and application of the colored ink composition in the same region of the fabric can be the same as the above difference in time between application of the reactive liquid and application of the clear ink composition.

### 1.2.2 Clear Ink Composition

The clear ink composition used in the anionic clear ink application step of the ink jet recording method according to the present embodiment is an anionic clear ink composition containing the first anionic resin particle and the water. Hereinafter, each component contained in the clear ink composition will be described.

The clear ink composition being “anionic” means including at least one or more anionic components.

### 1.2.2.1 First Anionic Resin Particle

The clear ink composition contains the first anionic resin particle. Like a function of a resin particle, the first anionic resin particle has a function as a so-called fixing resin of improving adhesion of the ink applied to the fabric. The first anionic resin particle also has a function of reacting with the above reactive liquid to agglomerate and thickening the clear ink composition. While the first anionic resin particle is generally handled in an emulsion form, the first anionic resin particle may have a property of powder.

The “anionic resin particle” means a resin particle having a negative charge as a whole resin particle and preferably has one or more anionic groups selected from a carboxyl group, a sulfonic acid group, a phosphoric acid group, and the like.

Examples of the first anionic resin particle include resin particles consisting of a urethane resin, an acryl resin (including a styrene-acryl resin), a fluorene resin, an olefin resin, a rosin-modified resin, a terpene resin, an ester resin, an amide resin, an epoxy resin, a vinyl chloride resin, a vinyl chloride-vinyl acetate copolymer, an ethylene vinyl acetate resin, and the like. Among the examples, the urethane resin, the acryl resin, the olefin resin, and the ester resin are preferably used. One type of the first anionic resin particle may be used alone, or two or more types of the first anionic resin particle may be used in combination.

The urethane resin is a general term for resins having a urethane bond. A polyether-type urethane resin including an ether bond in a main chain, an ester-type urethane resin including an ester bond in a main chain, a carbonate-type urethane resin including a carbonate bond in a main chain, or the like other than the urethane bond may also be used as the urethane resin. A commercially available product of the urethane resin may be used. Examples thereof include Superflex 460, 460s, 840, and E-4000 (product names, manufactured by DKS Co., Ltd.), Resamine D-1060, D-2020, D-4080, D-4200, D-6300, and D-6455 (product names, manufactured by Dainichiseika Color & Chemicals MFG Co., Ltd.), Takelac WS-5100, WS-6021, and W-512-A-6 (product names, manufactured by Mitsui Chemicals Polyurethanes, Inc.), Sancure 2710 (product name, manufactured by LUBRIZOL), and Permarin UA-150 (product name, manufactured by Sanyo Chemical Industries Ltd.).

The acryl resin is a general term for polymers obtained by polymerizing at least an acryl monomer such as (meth)acrylic acid and (meth)acrylate as one component. Examples of the acryl resin include a resin obtained from an acryl monomer, and a copolymer of an acryl monomer and a monomer other than the acryl monomer. Examples of the acryl resin also include an acrylic-vinyl resin that is a copolymer of an acryl monomer and a vinyl monomer. Examples of the vinyl monomer include styrene.

As the acryl monomer, acrylamide, acrylonitrile, and the like can also be used. A commercially available product of a resin emulsion using the acryl resin as a raw material may be used. For example, a product selected from FK-854 (product name, manufactured by CHUORIKA KOUGYO Co., Ltd.), Mowinyl 952B and 718A (product names, manufactured by The Nippon Synthetic Chemical Industry Co., Ltd.), and Nipol LX852 and LX874 (product names, manufactured by Zeon Corporation) may be used.

The styrene-acryl resin is a copolymer obtained from a styrene monomer and a (meth)acryl monomer. Examples of the styrene-acryl resin include a styrene-acrylic acid copolymer, a styrene-methacrylic acid copolymer, a styrene-methacrylic acid-acrylate copolymer, a styrene-α-methylstyrene-acrylic acid copolymer, and a styrene-α-methylstyrene-acrylic acid-acrylate copolymer. A commercially available product of the styrene-acryl resin may be used. For example, Joncryl 62J, 7100, 390, 711, 511, 7001, 632, 741, 450, 840, 74J, HRC-1645J, 734, 852, 7600,775, 537J, 1535, PDX- 7630A, 352J, 352D, PDX- 7145, 538J, 7640, 7641, 631, 790, 780, and 7610 (product names, manufactured by BASF), Mowinyl 966A and 975N (product names, manufactured by The Nippon Synthetic Chemical Industry Co., Ltd.), and VINYBLAN 2586 (manufactured by Nissin Chemical Industry Co., Ltd.) may be used.

The olefin resin is a polymer having olefin such as ethylene, propylene, and butylene in a structural skeleton. Well-known olefin resins can be appropriately selected for use. A commercially available product of the olefin resin can be used. For example, ARROWBASE CB-1200 and CD-1200 (product names, manufactured by Unitika Ltd.) may be used.

The first anionic resin particle is more preferably a urethane resin or an acryl resin and further preferably a urethane resin. In this case, rubbing fastness tends to be further enhanced.

A glass transition temperature (Tg) of the first anionic resin particle is preferably −60° C. or higher and 50° C. or lower, more preferably −60° C. or higher and 40° C. or lower, and further preferably −30° C. or higher and 10° C. or lower. When the glass transition temperature (Tg) of the first anionic resin particle is within this range, a property that follows the fabric (texture) tends to be further enhanced. For example, the glass transition temperature is measured in accordance with JIS K 7121 (Measurement Methods for Transition Temperatures of Plastics) using a differential scanning calorimeter “DSC 7000” manufactured by Hitachi High-Tech Science Corporation.

A content (solid concentration) of the first anionic resin particle is preferably 1% to 30% by mass, more preferably 2% to 25% by mass, further preferably 4% to 20% by mass, particularly preferably 6% to 15% by mass, and more particularly preferably 8% to 12% by mass with respect to a total amount of the clear ink composition. When the content of the first anionic resin particle is within this range, a further enhanced color developing property tends to be achieved.

### 1.2.2.2 Water

The clear ink composition contains the water. As the water, the same water as the above reactive liquid can be used.

A content of the water is preferably 20% by mass or more, further preferably 30% by mass or more, more preferably 40% by mass or more, and particularly preferably 50% by mass or more with respect to the total amount of the clear ink composition. An upper limit of the content of the water is not particularly limited and is, for example, preferably 90% by mass or less, further preferably 70% by mass or less, and more preferably 60% by mass or less with respect to the total amount of the clear ink composition.

### 1.2.2.3 Organic Solvent

The clear ink composition may contain an organic solvent. A type, a content, and the like of the organic solvent can be the same as those of the above reactive liquid.

In the clear ink composition, the organic solvent preferably includes alkanediols, glycol ethers, and trialkylene glycol, more preferably includes 1,2-alkanediol, glycol ethers, and trialkylene glycol, and further preferably includes propylene glycol, triethylene glycol monobutyl ether, and triethylene glycol. When the organic solvent includes these solvents, reduction of image cracking and reduction of ink bleeding may be further enhanced.

A content of the organic solvent is preferably 10% to 55% by mass, more preferably 15% to 45% by mass, further preferably 20% to 40% by mass, and particularly preferably 25% to 35% by mass with respect to the total amount of the clear ink composition. When the content of the organic solvent is within this range, reduction of image cracking and reduction of ink bleeding may be further enhanced.

### 1.2.2.4 Surfactant

The clear ink composition may contain a surfactant. A type and the like of the surfactant can be the same as those of the above reactive liquid. The clear ink composition preferably contains a silicone-based surfactant as the surfactant.

A lower limit of a content of the surfactant is preferably 0.05% by mass or more, further preferably 0.1% by mass or more, more preferably 0.2% by mass or more, and particularly preferably 0.3% by mass or more with respect to the total amount of the clear ink composition.

An upper limit of the content of the surfactant is preferably 3% by mass or less, more preferably 2% by mass or less, further preferably 1% by mass or less, and particularly preferably 0.8% by mass or less with respect to the total amount of the clear ink composition. When the content of the surfactant is within this range, permeability of the fabric for the clear ink composition tends to be easily adjusted to preferable permeability.

### 1.2.2.5 pH Adjuster

The clear ink composition may contain a pH adjuster.

The pH adjuster is not particularly limited. Examples thereof include an appropriate combination of an acid, a base, a weak acid, and a weak base.

As examples of the acid and the base used in such a combination, examples of an inorganic acid include sulfuric acid, hydrochloric acid, and nitric acid. Examples of an inorganic base include lithium hydroxide, sodium hydroxide, potassium hydroxide, potassium dihydrogen phosphate, disodium hydrogen phosphate, potassium carbonate, sodium carbonate, sodium hydrogen carbonate, and ammonia. Examples of an organic base include triethanol amine, diethanol amine, monoethanol amine, tripropanol amine, triisopropanol amine, diisopropanol amine, and tris(hydroxymethyl)aminomethane (THAM). As an organic acid, Good's buffers such as adipic acid, citric acid, succinic acid, lactic acid, N,N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), carbamoylmethyl iminobisacetic acid (ADA), piperazine-1,4-bis(2-ethanesulfonic acid) (PIPES), N-(2-acetamide)-2-aminoethanesulfonic acid (ACES), cholamine chloride, N-tris(hydroxymethyl)methyl-2-aminoethanesulfonic acid (TES), acetamide glycine, tricine, glycine amide, and bicine, a phosphate buffer liquid, a citrate buffer liquid, a Tris buffer liquid, and the like may be used. Among the examples, the inorganic base is preferably used, and potassium hydroxide is more preferably used.

One type of the pH adjuster may be used alone, or two or more types of the pH adjuster may be used in combination.

A total content of the pH adjuster is preferably 3.00% by mass or less, more preferably 1.00% by mass or less, further preferably 0.50% by mass or less, particularly preferably 0.30% by mass or less, and more particularly preferably 0.20% by mass or less with respect to the total amount of the clear ink composition. A lower limit of the total content of the pH adjuster is not particularly limited and is preferably 0.01% by mass or more, further preferably 0.05% by mass or more, more preferably 0.10% by mass or more, and further preferably 0.15% by mass or more with respect to the total amount of the clear ink composition.

### 1.2.2.6 Other Components

The clear ink composition may contain various additives such as a preservative or a fungicide, a rust inhibitor, a chelator, a viscosity adjuster, a dissolution aid, and an antioxidant, as necessary. A content of such an additive when contained is preferably 0.1% to 5% by mass, more preferably 0.1% to 3% by mass, and further preferably 0.1% to 1% by mass with respect to the total amount of the clear ink composition.

The clear ink composition may contain a coloring material such as a pigment. A content of the coloring material is preferably 0.2% by mass or less, more preferably 0.1% by mass or less, and further preferably 0.05% by mass or less with respect to the total amount of the clear ink composition, and a lower limit of the content is 0% by mass. The clear ink composition preferably does not contain a coloring material.

### 1.2.2.7 Physical Property

A pH of the clear ink composition is not particularly limited and is preferably greater than 7, more preferably greater than 7 and less than or equal to 10, and further preferably greater than 7 and less than or equal to 8.

Viscosity of the clear ink composition is preferably 1.0 to 10 mPa·s, more preferably 1.5 to 8 mPa·s, further preferably 3.0 to 8.0 mPa·s, still more preferably 3.0 to 5.0 mPa·s, and particularly preferably 3.0 to 4.0 mPa·s at 20° C. In particular, when the viscosity is 3.0 mPa·s or more, a more favorable color developing property tends to be achieved. When the viscosity is 8.0 mPa·s or less, more favorable stability of ejection tends to be achieved.

Surface tension of the clear ink composition is preferably 10 to 40 mN/m, more preferably 15 to 35 mN/m, further preferably 20 to 30 mN/m, and particularly preferably 20 to 27 mN/m at 20° C.

### 1.3 Anionic Colored Ink Application Step

The ink jet recording method according to the present embodiment includes the anionic colored ink application step of applying the anionic colored ink composition containing the pigment, the second anionic resin particle, and the water to the region to which the clear ink composition is applied, using the ink jet method.

### 1.3.1 Aspect of Application

### 1.3.1.1 Application Amount

The application amount (V_{w}) of the colored ink composition per unit area of the fabric in the anionic colored ink application step is not particularly limited and is preferably 0.010 g/inch² or more, more preferably 0.050 g/inch² or more, further preferably 0.080 g/inch² or more, still more preferably 0.120 g/inch² or more, and particularly preferably 0.150 g/inch² or more. The application amount (V_{w}) of the colored ink composition per unit area of the fabric is preferably 0.300 g/inch² or less, more preferably 0.200 g/inch² or less, and further preferably 0.170 g/inch² or less.

When the application amount of the colored ink composition is 0.010 g/inch² or more, a more favorable color developing property tends to be achieved. When the application amount of the colored ink composition is 0.300 g/inch² or less, image cracking tends to be further reduced.

### 1.3.1.2 Order of Application

In the ink jet recording method according to the present embodiment, an order in which the anionic colored ink application step is performed is the same as the above described order in which the anionic clear ink application step is performed.

The anionic colored ink application step and the anionic clear ink application step may be performed as simultaneous application in which the colored ink composition and the clear ink composition are applied to the same region of the fabric in the same scanning, or layered application in which the colored ink composition and the clear ink composition are applied to the same region of the fabric in different scannings.

### 1.3.2 Colored Ink Composition

The colored ink composition used in the anionic colored ink application step of the ink jet recording method according to the present embodiment is an anionic colored ink composition containing the pigment, the second anionic resin particle, and the water. Hereinafter, each component contained in the colored ink composition will be described.

The colored ink composition being “anionic” means including at least one or more anionic components.

### 1.3.2.1 Pigment

The colored ink composition contains the pigment. As the pigment, for example, an inorganic pigment or an organic pigment can be used.

The inorganic pigment is not particularly limited. Examples thereof include carbon blacks such as C.I. Pigment Black 6 (lamp black, vegetable black), C.I. Pigment Black 7 (furnace black, channel black, thermal black, acetylene black), C.I. Pigment Black 8 (charcoal black), and C.I. Pigment Black 10 (graphite); and white pigments such as iron oxide, titanium oxide, zinc oxide, and silica.

Examples of the carbon black include No. 2300, 900, MCF88, No. 20B, No. 33, No. 40, No. 45, No. 52, MA7,MA8, MA100, and No2200B manufactured by Mitsubishi Chemical Corporation. Examples of the carbon black also include color black FW1, FW2, FW2V, FW18, FW200, S150, S160, and S170, Pretex 35, U, V, and 140U, and special black 6, 5, 4A, 4, and 250 manufactured by Degussa Corporation. Examples of the carbon black also include Conductex SC and Raven 1255, 5750, 5250, 5000, 3500, 1255, and 700 manufactured by Columbia Carbon Company. Examples of the carbon black also include Regal 400R, 330R, and 660R, Mogul L, Monarch 700, 800, 880, 900, 1000, 1100, 1300, and 1400, and Elftex 12 manufactured by Cabot Corporation.

Examples of the white pigment include C.I. Pigment White 1, which is basic lead carbonate, C.I. Pigment White 4 made of zinc oxide, C.I. Pigment White 5 made of a mixture of zinc sulfide and barium sulfate, C.I. Pigment White 6 made of titanium dioxide, C.I. Pigment White 6:1 made of titanium dioxide containing other metal oxides, C.I. Pigment White 7 made of zinc sulfide, C.I. Pigment White 18 made of calcium carbonate, C.I. Pigment White 19 made of clay, C.I. Pigment White 20 made of mica titanium, C.I. Pigment White 21 made of barium sulfate, C.I. Pigment White 22 made of gypsum, C.I. Pigment White 26 made of magnesium oxide and silicon dioxide, C.I. Pigment White 27 made of silicon dioxide, and C.I. Pigment White 28 made of anhydrous calcium silicate. Among the examples, C.I. Pigment White 6 providing an enhanced color developing property, a masking property, and the like is preferably used.

An average particle diameter of the white pigment is preferably 100 nm or more and 500 nm or less, more preferably 50 nm or more and 450 nm or less, and further preferably 200 nm or more and 400 nm or less. When the average particle diameter of the white pigment is within this range, stability of ejection from the ink jet head tends to be secured. In addition, the masking property tends to be improved. In the present specification, unless otherwise specified, the “average particle diameter” means a volume-based particle size distribution that is a particle diameter at 50% by volume cumulative distribution. The average particle diameter is measured using the dynamic light scattering method or the laser diffraction light method according to JIS Z8825. Specifically, a particle size distribution meter (for example, “Microtrac UPA” manufactured by Nikkiso Co., Ltd.) using the dynamic light scattering method as a measurement principle can be adopted.

Examples of the organic pigment include a quinacridone-based pigment, a quinacridone quinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzimidazolone-based pigment, an isoindolinone-based pigment, an azomethine-based pigment, and an azo-based pigment.

Specific examples of the organic pigment are as follows.

Examples of a cyan pigment include C.I. Pigment Blue 1, 2, 3, 15:3, 15:4, 15:34, 16, 22, and 60; and C.I. Vat Blue 4 and 60, and one or a mixture of two or more selected from a group consisting of C.I. Pigment Blue 15:3, 15:4, and 60 is preferably used.

Examples of a magenta pigment include C.I. Pigment Red 5, 7, 12, 48 (Ca), 48 (Mn), 57 (Ca), 57:1, 112, 122, 123, 168, 184, and 202 and C.I. Pigment Violet 19, and one or a mixture of two or more selected from a group consisting of C.I. Pigment Red 122, 202, and 209 and C.I. Pigment Violet 19 is preferably used.

Examples of a yellow pigment include C.I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, and 185, and one or a mixture of two or more selected from a group consisting of C.I. Pigment Yellow 74, 109, 110, 128, 138, 150, and 180 is preferably used.

Pigments of other colors can also be used. Examples of such pigments include an orange pigment and a green pigment.

One type of the pigment may be used alone, or two or more types of the pigment may be used in combination.

The colored ink composition is preferably a white ink composition (hereinafter also referred to as a “white ink”) containing a white pigment as the pigment. The colored ink composition containing the white pigment is suitable for forming a white ink layer as a base layer. However, a relatively large amount of the white ink needs to be applied. Thus, a large amount of the acidic reactive liquid needs to be applied, and the coating is likely to crack more noticeably. Meanwhile, according to the ink jet recording method according to the present embodiment, even the colored ink composition containing the white pigment tends to favorably reduce image cracking.

In the present specification, the term “white” in the white ink composition, the white pigment, and the like means not only a completely white color but also a range of colors colored with a chromatic color or an achromatic color and glossy colors visible as white. Inks or coloring materials that are named and sold with names regarded as a white ink or a white coloring material are also included.

More quantitatively, for example, “white” includes not only a color of which L^{*} is 100, but also a color of which L^{*} is 60 or more and 100 or less, and each of a^{*} and b^{*} is ±10 or less in CIELAB on a recorded matter.

More specifically, for example, lightness (L^{*}) and colors (a^{*} and b^{*}) of a recorded part of the recorded matter measured using a CIELAB-compliant spectrophotometer are preferably within this range when recording with the white ink composition is performed with an amount of the ink sufficiently covering a surface of the recording medium made of a clear film. For example, the recorded matter on which recording is performed with a sufficiently covering amount is an application amount of 15 mg/inch². More preferably, 80≤L^{*}≤100, −4.5≤a^{*}≤2, and −10≤b^{*}≤2.5are satisfied. Examples of the recording medium made of a clear film include LAG Jet E-1000ZC (manufactured by LINTEC Corporation). Examples of the CIELAB-compliant spectrophotometer include SPECTROLINO (product name, manufactured by GretagMacbeth), and measurement is performed by setting a measurement condition as D50 light source, an observation field as 2°, concentration as DIN NB, a white standard as Abs, a filter as No, and a measurement mode as Reflectance.

Colors other than “white” will be referred to as “non-white”.

The pigment may be used after dispersing the pigment using a pigment dispersant. The pigment may be used after dispersing the pigment as a self-dispersing pigment by oxidizing or sulfonating a surface of the pigment using ozone, hypochlorous acid, fuming sulfuric acid, or the like.

The pigment dispersant has a function of dispersing the pigment in the ink. The pigment dispersant may be water-soluble but is preferably not completely water-soluble. The pigment dispersant is considered to disperse the pigment by bonding to or adsorbing on the pigment in part or as a whole to increase hydrophilicity of a surface of the pigment.

The pigment dispersant is a polymer compound, and examples of the polymer compound include an acrylic resin such as poly(meth)acrylic acid, a (meth)acrylic acid-acrylonitrile copolymer, a (meth)acrylic acid-(meth)acrylate copolymer, a vinyl acetate-(meth)acrylate copolymer, a vinyl acetate-(meth)acrylic acid copolymer, a vinylnaphthalene-(meth)acrylic acid copolymer, a styrene-(meth)acrylic acid copolymer, a styrene-(meth)acrylic acid-(meth)acrylate copolymer, a styrene-α-methylstyrene-(meth)acrylic acid copolymer, and a styrene-α-methylstyrene-(meth)acrylic acid-(meth)acrylate copolymer and a salt thereof.

Examples of the pigment dispersant also include a maleic acid-based resin such as a styrene-maleic acid copolymer, a styrene-maleic anhydride copolymer, a vinylnaphthalene-maleic acid copolymer, and a vinyl acetate-maleate copolymer and a salt thereof; a urethane-based resin with or without a cross-linked structure and a salt thereof; polyvinyl alcohols; and a vinyl acetate-crotonic acid copolymer and a salt thereof.

The acrylic resin may include not only a polymer of an acrylic monomer as described above, but also a copolymer of an acrylic monomer and another monomer. For example, an acrylic vinyl resin of a copolymer with a vinyl-based monomer as the other monomer is also referred to as the acrylic resin. The acrylic resin also includes, for example, a copolymer of a styrene-based monomer and an acrylic monomer among the styrene-based resins. The acrylic resin also includes a salt and an esterified product thereof.

Examples of a commercially available product of the pigment dispersant include X-200, X-1, X-205, X-220, and X-228 (manufactured by Seiko PMC Corporation), Nopco Sperse (registered trademark) 6100 and 6110 (manufactured by San Nopco Ltd.), Joncryl 67, 586, 611, 678, 680, 682, and 819 (manufactured by BASF), DISPERBYK-190 (manufactured by BYK Chemie Japan Co., Ltd.), and N-EA137, N-EA157, N-EA167, N-EA177,N-EA197D, N-EA207D, and E-EN10 (manufactured by DKS Co., Ltd.).

Examples of a commercially available product of the acrylic pigment dispersant include BYK-187, BYK-190, BYK-191, BYK-194N, and BYK-199 (manufactured by BYK Chemie Japan Co., Ltd.) and Aron A-210, A6114, AS-1100, AS-1800, A-30SL, A-7250, and CL-2 (manufactured by Toagosei Co., Ltd.).

Examples of a commercially available product of the urethane-based pigment dispersant include BYK-182, BYK-183, BYK-184, and BYK-185 (manufactured by BYK Chemie Japan Co., Ltd.), TEGO Disperse 710 (manufactured by Evonik Tego Chemie GmbH), and Borchi (registered trademark) Gen 1350 (manufactured by OMG Borschers GmbH).

The pigment dispersant is preferably an anionic pigment dispersant. The “anionic pigment dispersant” means a pigment dispersant having a negative charge as a whole pigment dispersant and preferably has one or more anionic groups selected from a carboxyl group, a sulfonic acid group, a phosphoric acid group, and the like.

The pigment in the colored ink composition is preferably anionic. In this case, agglomeration action caused by the above reactive liquid is further enhanced. Thus, a more favorable color developing property tends to be achieved.

The pigment being anionic means having a negative charge as a whole pigment. For example, one or more anionic groups selected from a carboxyl group, a sulfonic acid group, and a phosphoric acid group are preferably used. The anionic group may be directly present on the surface of the pigment or may be present via an anionic resin dispersant adsorbed on or bonded to the pigment.

One type of the pigment dispersant may be used alone, or two or more types of the pigment dispersant may be used in combination. A total content of the pigment dispersant is preferably 0.1% by mass or more and 30% by mass or less, more preferably 0.5% by mass or more and 25% by mass or less, further preferably 1% by mass or more and 20% by mass or less, and particularly preferably 1.5% by mass or more and 15% by mass or less with respect to 100% by mass of the colored ink composition. When the content of the pigment dispersant is 0.1% by mass or more, stability of dispersion of the pigment tends to be secured. When the content of the pigment dispersant is 30% by mass or less, viscosity of the colored ink composition tends to be further reduced.

A weight average molecular weight of the pigment dispersant is further preferably 500 or more. Using such a pigment dispersant reduces odor, and further favorable stability of dispersion of the pigment tends to be achieved.

When the pigment (in particular, the white pigment) is dispersed by the pigment dispersant, a ratio of the pigment to the pigment dispersant is preferably 10:1 to 1:10 and more preferably 4:1 to 1:3.

A content of the pigment (in particular, the white pigment) is preferably 1% to 30% by mass, more preferably 2% to 25% by mass, further preferably 4% to 20% by mass, particularly preferably 6% to 15% by mass, and more particularly preferably 8% to 12% by mass with respect to a total amount of the colored ink composition. When the content of the pigment is within this range, a further favorable color developing property (whiteness) tends to be achieved.

### 1.3.2.2 Second Anionic Resin Particle

The colored ink composition contains the second anionic resin particle. The second anionic resin particle can have the same aspect as the above first anionic resin particle contained in the clear ink composition and thus, will not be described. The second anionic resin particle and the first anionic resin particle may be the same as or different from each other.

When the colored ink composition contains the second anionic resin particle, a sealing effect of the colored ink composition is further exhibited on the resin layer formed near the surface of the fabric by the first anionic resin particle agglomerated in the clear ink, and the color developing property and the like tend to be further improved.

The second anionic resin particle in the colored ink composition is preferably a urethane resin or an acryl resin and more preferably a urethane resin. In this case, rubbing fastness tends to be further enhanced.

A glass transition temperature (Tg) of the second anionic resin particle in the colored ink composition is preferably −60° C. or higher and 50° C. or lower, more preferably −60° C. or higher and 40° C. or lower, and further preferably −30° C. or higher and 10° C. or lower. When the glass transition temperature (Tg) of the second anionic resin particle is within this range, the property that follows the fabric (texture) tends to be further enhanced.

A content (solid concentration) of the second anionic resin particle is preferably 1% to 30% by mass, more preferably 2% to 25% by mass, further preferably 4% to 20% by mass, particularly preferably 6% to 15% by mass, and more particularly preferably 8% to 12% by mass with respect to the total amount of the colored ink composition. When the content of the second anionic resin particle is within this range, reduction of image cracking and reduction of ink bleeding tend to be further enhanced.

### 1.3.2.3 Water

The colored ink composition contains the water. As the water, the same water as the above reactive liquid can be used.

A content of the water is preferably 20% by mass or more, further preferably 30% by mass or more, more preferably 40% by mass or more, and particularly preferably 50% by mass or more with respect to the total amount of the colored ink composition. An upper limit of the content of the water is not particularly limited and is, for example, preferably 90% by mass or less and further preferably 70% by mass or less with respect to the total amount of the colored ink composition.

### 1.3.2.4 Organic Solvent

The colored ink composition may contain an organic solvent. A type, a content, and the like of the organic solvent can be the same as those of the above reactive liquid.

In the colored ink composition, the organic solvent preferably includes alkanediols, glycol ethers, and trialkylene glycol, more preferably includes 1,2-alkanediol, glycol ethers, and trialkylene glycol, and further preferably includes propylene glycol, triethylene glycol monobutyl ether, and triethylene glycol. When the organic solvent includes these solvents, reduction of image cracking and reduction of ink bleeding may be further enhanced.

The colored ink composition further preferably contains 3.0% by mass or more, more preferably 5.0% by mass or more, and further preferably 7.0% by mass or more of an organic solvent having a standard boiling point of 250° C. or higher. An upper limit of a content of the organic solvent is not particularly limited and is preferably 20% by mass or less, more preferably 15% by mass or less, and further preferably 10% by mass or less.

When the organic solvent having a standard boiling point of 250° C. or higher is contained within this range, humidity of the nozzle of the ink jet head is maintained, and further favorable reliability of ejection (stability of continuous printing) tends to be achieved.

Examples of the organic solvent having a standard boiling point of 250° C. or higher include glycerin and polyethylene glycol monomethyl ether. The organic solvent having a standard boiling point of 250° C. or higher is also referred to as a moisturizer. The organic solvent having a standard boiling point of 250° C. or higher more preferably has a standard boiling point of 270° C. or higher and further preferably has a standard boiling point of 280° C. or higher.

The content of the organic solvent is preferably 5% to 50% by mass, more preferably 10% to 40% by mass, further preferably 15% to 30% by mass, and particularly preferably 20% to 25% by mass with respect to the total amount of the colored ink composition. When the content of the organic solvent is within this range, reduction of image cracking and reduction of ink bleeding may be further enhanced.

### 1.3.2.5 Surfactant

The colored ink composition may contain a surfactant. A type and the like of the surfactant can be the same as those of the above reactive liquid. The colored ink composition preferably contains a silicone-based surfactant as the surfactant.

A lower limit of a content of the surfactant is preferably 0.05% by mass or more, further preferably 0.1% by mass or more, more preferably 0.2% by mass or more, and particularly preferably 0.3% by mass or more with respect to the total amount of the colored ink composition.

An upper limit of the content of the surfactant is preferably 3% by mass or less, more preferably 2% by mass or less, further preferably 1% by mass or less, and particularly preferably 0.5% by mass or less with respect to the total amount of the colored ink composition. When the content of the surfactant is within this range, permeability of the fabric for the colored ink composition tends to be easily adjusted to preferable permeability.

### 1.3.2.6 pH Adjuster

The colored ink composition may contain a pH adjuster. A type, a content, and the like of the pH adjuster can be the same as those of the above clear ink composition.

### 1.3.2.7 Other Components

The colored ink composition may contain additives such as a preservative or a fungicide, a rust inhibitor, a chelator, a viscosity adjuster, a dissolution aid, and an antioxidant, as necessary. A content of such an additive when contained is preferably 0.1% to 5% by mass, more preferably 0.1% to 3% by mass, and further preferably 0.1% to 1% by mass with respect to the total amount of the colored ink composition.

### 1.3.2.8 Physical Property

A pH of the colored ink composition is not particularly limited and is preferably greater than 7, more preferably greater than 7 and less than or equal to 10, and further preferably greater than 7 and less than or equal to 8.

The viscosity of the colored ink composition is preferably 1.0 to 10 mPa·s, more preferably 2.0 to 10 mPa·s, further preferably 3.0 to 8.0 mPa·s, and particularly preferably 4.0 to 6.0 mPa·s at 20° C. In particular, when the viscosity is 4.0 mPa·s or more, a more favorable color developing property tends to be achieved. When the viscosity is 6.0 mPa·s or less, more favorable stability of ejection tends to be achieved.

Surface tension of the colored ink composition is preferably 10 to 40 mN/m, more preferably 15 to 35 mN/m, further preferably 20 to 30 mN/m, and particularly preferably 20 to 27 mN/m at 20° C.

### 1.4 Anionic Solution Application Step

The ink jet recording method according to the present embodiment includes the anionic solution application step of applying the anionic aqueous alkaline solution having a pH greater than 8.0 to the region to which the colored ink composition is applied.

### 1.4.1 Aspect of Application

### 1.4.1.1 Application Method

An application method of the aqueous alkaline solution in the anionic solution application step is not particularly limited. Examples thereof include an immersion application method of immersing the fabric in the aqueous alkaline solution, a roller application method of applying the aqueous alkaline solution using a mangle roller, a roll coater, or the like, a spray application method of ejecting the aqueous alkaline solution using a spray apparatus or the like, and an ink jet application method of ejecting the aqueous alkaline solution using the ink jet method.

For these application methods, one method may be used alone to apply the aqueous alkaline solution to the fabric, or two or more methods may be used in combination to apply the aqueous alkaline solution to the fabric.

The anionic solution application step is preferably performed using a method that enables the aqueous alkaline solution to be applied to only the region to which the colored ink composition is applied, and particularly preferably using the ink jet method. When the anionic solution application step is performed using the ink jet method, an application region and an application amount can be precisely controlled. Thus, a necessary and sufficient amount of the aqueous alkaline solution can be evenly applied to the region to which the colored ink is applied, and reduction of image cracking and reduction of ink bleeding tend to be further enhanced.

### 1.4.1.2 Application Amount

The application amount (Vₙ) of the aqueous alkaline solution per unit area of the fabric in the anionic solution application step is not particularly limited and is preferably 0.010 g/inch² or more, more preferably 0.050 g/inch² or more, further preferably 0.080 g/inch² or more, still more preferably 0.120 g/inch² or more, and particularly preferably 0.150 g/inch² or more. The application amount (Vₙ) of the aqueous alkaline solution per unit area of the fabric is preferably 0.300 g/inch² or less, more preferably 0.200 g/inch² or less, and further preferably 0.170 g/inch² or less.

When the application amount of the aqueous alkaline solution is 0.010 g/inch² or more, more favorable reduction of image cracking tends to be achieved.

### 1.4.1.3 Order of Application

In the ink jet recording method according to the present embodiment, an order in which the anionic solution application step is performed is not particularly limited as long as having an aspect in which the aqueous alkaline solution can be applied to the region to which the colored ink composition is applied. For example, the anionic solution application step may be performed after or at the same time as the anionic colored ink application step. However, when the anionic solution application step is performed at the same time as the anionic colored ink application step, this results in an aspect in which the colored ink composition is applied to the fabric first, and then the aqueous alkaline solution is applied to the fabric.

The anionic solution application step and the anionic colored ink application step may be performed as simultaneous application in which the aqueous alkaline solution and the colored ink composition are applied to the same region of the fabric in the same scanning, or layered application in which the aqueous alkaline solution and the colored ink composition are applied to the same region of the fabric in different scannings.

When the simultaneous application is performed, as the order of landing on the fabric, the colored ink composition needs to be applied first, and then the aqueous alkaline solution needs to be applied.

A difference in time between application of the aqueous alkaline solution and application of the colored ink composition in the same region of the fabric can be the same as the above difference in time between application of the reactive liquid and application of the clear ink composition.

### 1.4.2 Aqueous Alkaline Solution

The aqueous alkaline solution used in the anionic solution application step of the ink jet recording method according to the present embodiment is an anionic aqueous alkaline solution having a pH greater than 8.0.

The aqueous alkaline solution being “anionic” means having a pH greater than 7.

The pH of the aqueous alkaline solution is not particularly limited as long as being greater than 8.0 and is preferably 8.3 or more, more preferably 8.5 or more, further preferably 8.7 or more, and particularly preferably 9.0 or more. The pH of the aqueous alkaline solution is preferably 12.0 or less, more preferably 11.0 or less, and further preferably 10.0 or less.

The pH of the aqueous alkaline solution is preferably 11.0 or less from a viewpoint of reducing skin irritation.

Hereinafter, each component contained in the aqueous alkaline solution will be described.

### 1.4.2.1 Alkaline Component

The aqueous alkaline solution may contain an alkaline component. The alkaline component is not particularly limited as long as being a substance that dissolves in water to generate a hydroxide ion. Examples thereof include an anionic resin particle, inorganic alkali, and organic alkali.

From a viewpoint of efficiently neutralizing the excessive acid, the inorganic alkali or the organic alkali is preferably used. Accordingly, cracking of the coating can be more favorably reduced. From this viewpoint, it is preferable to use the inorganic alkali or the organic alkali and not use the anionic resin particle.

Meanwhile, from a viewpoint of neutralizing the excessive acid and increasing rubbing resistance of the coating, the anionic resin particle is preferably used.

The anionic resin particle has the same aspect as the above first anionic resin particle or the second anionic resin particle and thus, will not be described.

Examples of the inorganic alkali include lithium hydroxide, sodium hydroxide, potassium hydroxide, potassium dihydrogen phosphate, disodium hydrogen phosphate, potassium carbonate, sodium carbonate, sodium hydrogen carbonate, and ammonia.

Examples of the organic alkali include triethanol amine, diethanol amine, monoethanol amine, tripropanol amine, triisopropanol amine, diisopropanol amine, and tris(hydroxymethyl)aminomethane (THAM).

The aqueous alkaline solution preferably contains one or more selected from the anionic resin particle, the inorganic alkali, and the organic alkali as the alkaline component. When such an alkaline component is contained, the pH of the aqueous alkaline solution can be stably set to be greater than 8.0, and more favorable reduction of image cracking tends to be achieved.

A content of the alkaline component is preferably 0.03% by mass or more, more preferably 0.06% by mass or more, and particularly preferably 0.15% by mass or more with respect to a total amount of the aqueous alkaline solution. An upper limit of the content of the alkaline component is not particularly limited and is preferably 15.0% by mass or less, more preferably 12.0% by mass or less, and particularly preferably 10.0% by mass or less with respect to the total amount of the aqueous alkaline solution. When the inorganic alkali or the organic alkali is used, and the anionic resin particle is not used, the content of the alkaline component is preferably 2.0% by mass or less, more preferably 1.0% by mass or less, and particularly preferably 0.5% by mass or less.

### 1.4.2.2 Water

The aqueous alkaline solution contains water. As the water, the same water as the above reactive liquid can be used.

A content of the water is preferably 30% by mass or more, further preferably 40% by mass or more, more preferably 50% by mass or more, and particularly preferably 60% by mass or more with respect to the total amount of the aqueous alkaline solution. An upper limit of the content of the water is not particularly limited and is, for example, preferably 90% by mass or less and further preferably 80% by mass or less with respect to the total amount of the aqueous alkaline solution.

### 1.4.2.3 Organic Solvent

The aqueous alkaline solution may contain an organic solvent. A type, a content, and the like of the organic solvent can be the same as those of the above clear ink composition.

### 1.4.2.4 Surfactant

The aqueous alkaline solution may contain a surfactant. A type, a content, and the like of the surfactant can be the same as those of the above clear ink composition.

### 1.4.2.5 Other Components

The aqueous alkaline solution may contain various additives such as a preservative or a fungicide, a rust inhibitor, a chelator, a viscosity adjuster, a dissolution aid, and an antioxidant, as necessary. A content of such an additive when contained is preferably 0.1% to 5% by mass, more preferably 0.1% to 3% by mass, and further preferably 0.1% to 1% by mass with respect to the total amount of the aqueous alkaline solution.

The aqueous alkaline solution may contain a coloring material such as a pigment. A content of the coloring material is preferably 0.2% by mass or less, more preferably 0.1% by mass or less, and further preferably 0.05% by mass or less with respect to the total amount of the aqueous alkaline solution, and a lower limit of the content is 0% by mass. The aqueous alkaline solution preferably does not contain the coloring material.

The content of the alkaline component is preferably 80.0% by mass or more, more preferably 90.0% by mass or more, further preferably 95.0% by mass or more, and particularly preferably 99.0% by mass or more with respect to a solid component other than the surfactant in the aqueous alkaline solution.

### 1.4.2.6 Physical Property

Viscosity of the aqueous alkaline solution is preferably 1.0 to 10 mPa·s, more preferably 1.5 to 8 mPa·s, further preferably 3.0 to 8.0 mPa·s, still more preferably 3.0 to 5.0 mPa·s, and particularly preferably 3.0 to 4.0 mPa·s at 20° C. In particular, when the viscosity is 8.0 mPa·s or less, more favorable stability of ejection tends to be achieved when ejection is performed using the ink jet method.

Surface tension of the aqueous alkaline solution is preferably 10 to 40 mN/m, more preferably 15 to 35 mN/m, further preferably 20 to 30 mN/m, and particularly preferably 20 to 27 mN/m at 20° C.

### 1.5 Drying Step

The ink jet recording method according to the present embodiment may include a drying step after the above anionic solution application step. When the drying step is performed before the anionic solution application step, excessive agglomeration is likely to proceed because of the acid not neutralized by the anionic component in the ink, and image cracking may occur. Meanwhile, when the drying step is performed after the anionic solution application step, the remaining acid can be neutralized before excessive agglomeration proceeds. Thus, reduction of image cracking tends to be further enhanced.

A drying method in the drying step is not particularly limited. Examples thereof include a heat press, a belt conveyor oven, an atmospheric pressure steam method, a high pressure steam method, a thermofix method, and blowing. A heat source for drying is not particularly limited. For example, an infrared lamp can be used. Drying may be performed without heating.

A drying temperature is preferably a temperature at which the resin particle that may be included in the ink is fused to evaporate a medium such as moisture. For example, the drying temperature is preferably 100° C. or higher and 250° C. or lower, more preferably 120° C. or higher and 230° C. or lower, further preferably 130° C. or higher and 200° C. or lower, and particularly preferably 130° C. or higher and 180° C. or lower. Here, the drying temperature in the drying step means a surface temperature of the image or the like formed on the fabric. A duration of drying is not particularly limited and is, for example, preferably 10 seconds or more and 5 minutes or less, more preferably 20 seconds or more and 3 minutes or less, and further preferably 60 seconds or more and 3 minutes or less.

The drying step may be performed while applying a pressure using the heat press or the like. The pressure to be applied is not particularly limited and is preferably 1 to 10 N/cm², more preferably 1 to 8 N/cm², and further preferably 1 to 5 N/cm².

### 1.6 Other Steps

The ink jet recording method according to the present embodiment may include rinsing the fabric on which recording is performed, performing heating and drying again, and the like. In rinsing, components such as the ink not fixed on the fabric may be washed out using a hot soap liquid or the like, as necessary, as soaping treatment.

### 1.7 Ink Jet Recording Apparatus

The ink jet recording apparatus that can be preferably used for the ink jet recording method according to the present embodiment will be described.

As an example of the ink jet recording apparatus, FIG. 1 shows a perspective view of a serial printer. As shown in FIG. 1, a serial printer 20 includes a transport portion 220 and a recording portion 230. The transport portion 220 transports the recording medium F fed to the serial printer to the recording portion 230, and the recording medium after recording is discharged outside the serial printer. Specifically, the transport portion 220 includes each feeding roller and transports the fed recording medium F in the transport direction TD.

The recording portion 230 includes the carriage 234 on which the ink jet head 231 including a nozzle for ejecting the above reactive liquid, a nozzle for ejecting the above clear ink composition, a nozzle for ejecting the above colored ink composition, and a nozzle for ejecting the above aqueous alkaline solution, as necessary, to the recording medium F fed from the transport portion 220 is mounted, and a carriage moving mechanism 235 for moving the carriage 234 in the scanning direction SD of the recording medium F.

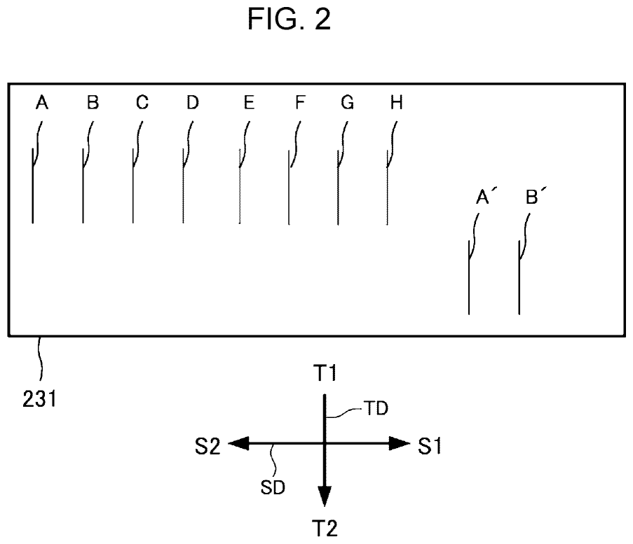

FIG. 2 shows an example of each nozzle array provided on a nozzle surface of the ink jet head 231. In FIG. 2, the ink jet head 231 includes a plurality of nozzle arrays, that is, arrays A to H and arrays A′ and B′ along the scanning direction SD, each consisting of a plurality of nozzles arranged along a direction (the transport direction TD) intersecting with a direction (the scanning direction SD) in which the ink jet head 231 is moved.

By disposing a nozzle array for ejecting the reactive liquid to at least partially overlap with a nozzle array for ejecting the clear ink composition in the transport direction TD when projected along the scanning direction SD, the reactive liquid and the clear ink composition can be applied to the same region of the fabric in the same scanning. In the same manner, the reactive liquid and the colored ink composition can be applied to the same region of the fabric in the same scanning.

The ink and the like to be ejected from each nozzle array are appropriately selected. For example, the arrays A and B are preferably selected as a nozzle array for ejecting the reactive liquid. The arrays C and D are preferably selected as a nozzle array for ejecting the clear ink composition. The arrays E to H are preferably selected as a nozzle array for ejecting the colored ink composition. The arrays A′ and B′ are preferably selected as a nozzle array for ejecting the aqueous alkaline solution.

When the serial printer is used, a head having a length less than the width of the recording medium is provided as the ink jet head 231, and recording is performed while the head moves in the scanning direction SD intersecting with the transport direction TD of the recording medium F. In the serial printer, the head 231 is mounted on the carriage 234 that moves in a predetermined direction, and the ink compositions, the reactive liquid, and, as necessary, the aqueous alkaline solution are ejected to the recording medium by moving the head in accordance with movement of the carriage. The recording medium may be transported between each scanning.

The ink jet recording apparatus is not limited to the printer of the serial type and may be a printer of the line type. FIG. 3 shows a schematic side view of a line printer as another example of the ink jet recording apparatus. As shown in FIG. 3, a line printer 1 includes a feeding portion 100, a transport mechanism 200 for transporting the recording medium in the transport direction, the line head 300 that ejects the ink to apply the ink to the recording medium, a control portion 500, and a discharge portion 700.

The transport mechanism is a mechanism for transporting the recording medium in the transport direction. In FIG. 3, the roll-shaped recording medium F is supplied from the feeding portion 100 to the transport mechanism 200, and the transport mechanism 200 is configured to transport the recording medium F fed from the feeding portion 100 to the line head 300. Specifically, the transport mechanism 200 includes a first feeding roller 201 and a second feeding roller 202 and is configured to transport the fed recording medium F to the line head 300 downstream in the transport direction. As a transport method of the transport mechanism 200, a well-known method in the related art can be appropriately used, or one or a plurality of rollers, a belt fed by a roller, or the like may be used.

The line printer 1 includes the line head 300 having a length corresponding to the width of the recording medium F. The line head 300 may be configured with a plurality of line jets. In FIG. 3, the line head 300 is configured with a first line head 310, a second line head 320, a third line head 330, and a fourth line head 340. The first line head 310, the second line head 320, the third line head 330, and the fourth line head 340 will be simply referred to as the line head 300 unless necessary to distinguish therebetween.

The line head 300 has cavities for accommodating the reactive liquid, the clear ink composition, the colored ink composition, and, as necessary, the aqueous alkaline solution (the ink and the like), an ejection driving portion provided for each cavity, and nozzles for ejecting the ink and the like. A plurality of cavities and a plurality of ejection driving portions and nozzles provided for each cavity may be provided in one head independently of each other. The ejection driving portion can be formed using an electromechanical conversion element such as a piezoelectric element that mechanically deforms to change a volume of the cavities, an electronic heat conversion element that emits heat to generate an air bubble in the ink and eject the ink, or the like.

For example, the line head 300 is preferably configured to eject the reactive liquid from the first line head 310 and eject the clear ink composition from the second line head 320. By doing so, the reactive liquid and the clear ink composition can be applied to the same region of the fabric in the same scanning. It is preferable to eject the colored ink composition from the third line head 330 and eject the aqueous alkaline solution from the fourth line head 340.

In the line printer, the head is fixed and (substantially) does not move, and recording is performed in a single scanning of the ink jet head. The line printer is more advantageous than the serial printer in terms of a high recording speed.

### 2. Example

Hereinafter, the present disclosure will be more specifically described with reference to examples. It should be noted that the present disclosure is not limited to those examples. Unless otherwise specified, “%” below is based on mass.

### 2.1 Preparation of Reactive Liquid, Clear Ink Composition,

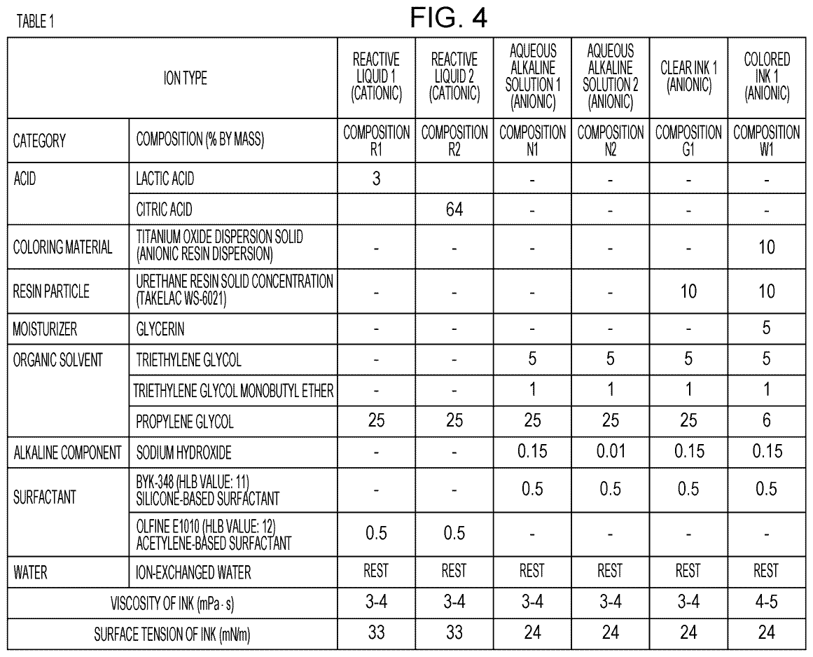

Colored Ink Composition, and Aqueous Alkaline Solution Each component is put into a container to obtain the composition in Table 1 (FIG. 4) and is mixed, stirred, and then filtered through a 5-μm membrane filter to obtain the reactive liquid (composition R1 and composition R2), the clear ink composition (composition G1), the colored ink composition (composition W1), and the aqueous alkaline solution (composition N1 and composition N2) of each example. Unless otherwise specified, numerical values of each component shown in each example in the table indicate % by mass. The % by mass of the pigment and the resin particle in the table indicates solid concentration, and the ion-exchanged water is added such that a total mass of the composition is 100% by mass.

A titanium oxide dispersion prepared in advance using the following procedure is used as the pigment. C.I. Pigment White 6 (relative density: 4.2 g/mL) is used as the pigment, and an anionic resin dispersant is used as the pigment dispersant. Specifically, a styrene-acryl resin synthesized using 55% by mass of styrene, 20% by mass of acrylic acid, and 30% by mass of methyl methacrylate is used. One part by mass of the dispersant and 10 parts by mass of the ion-exchanged water are used to mix with three parts by mass of the pigment. The obtained mixture is premixed and then dispersed at a peripheral speed of 10 m/s at a liquid temperature of 30° C. for 15 minutes using zirconia beads having a diameter of 0.03 mm using a bead mill disperser (UAM-015 manufactured by Kotobuki Kogyou Co., Ltd.). Coarse particles are centrifugally separated using a centrifugal separator (Model-3600 manufactured by Kuboyama Shoji Co., Ltd.) to obtain the titanium oxide dispersion (reactive to cations).

Supplementary descriptions will be provided for the items shown in Table 1.
Takelac WS-6021 (product name, manufactured by Mitsui Chemicals Polyurethanes, Inc. ; this product is also used for the urethane resin in Table 2)
BYK-348 (product name, manufactured by BYK, silicon-based surfactant)
OLFINE E1010 (product name, manufactured by Nissin Chemical Industry Co., Ltd., acetylene glycol-based surfactant)

Viscosity is measured in an environment of 20° C. using a viscoelasticity tester MCR-300 (product name, manufactured by Pysica).

Surface tension was measured by identifying surface tension when a platinum plate is wetted with the composition in an environment of 25° C. using an automatic surface tensiometer CBVP-Z (product name, manufactured by Kyowa Interface Science Co., Ltd.).

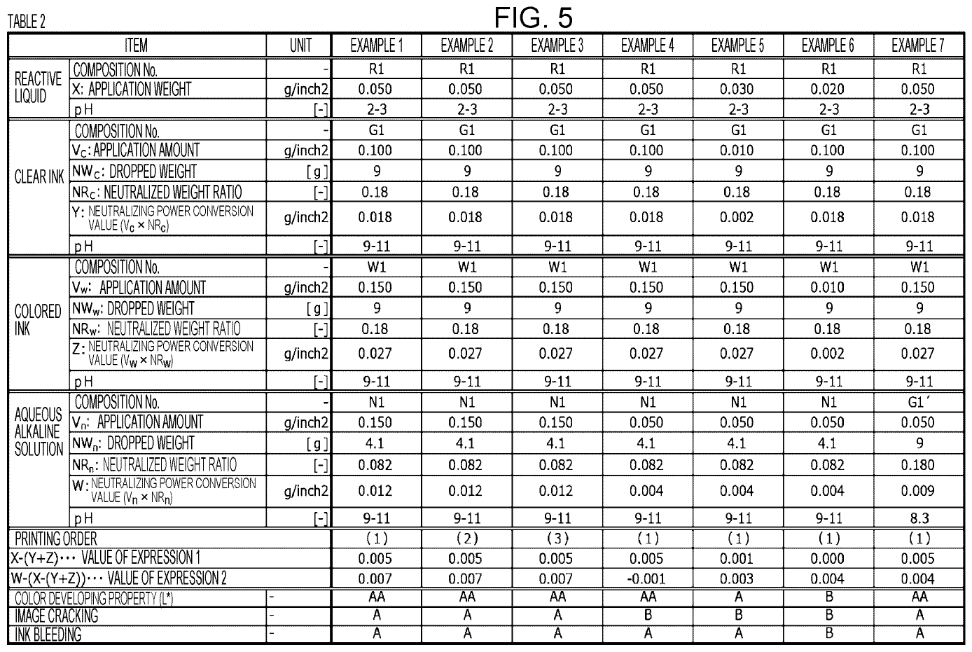

In Example 7 in Table 2 (FIG. 5), composition G1′ that is the same as the composition G1 except for having a pH of 8.3 by adjusting the contents of the alkaline component and the water in the composition of the clear ink (composition G1) is used as the aqueous alkaline solution.

### 2.2 Recording Condition

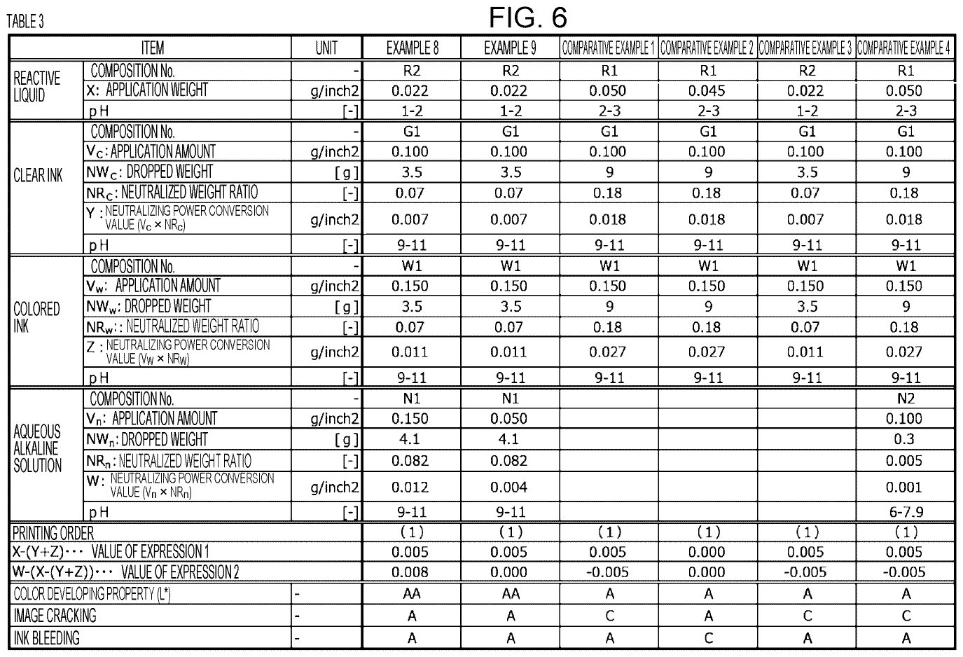

The recorded matter is obtained by performing the ink jet recording method according to each example and each comparative example based on the following conditions and the conditions according to Table 2 (FIG. 5) and Table 3 (FIG. 6) using the reactive liquid (composition R1 and composition R2), the clear ink composition (composition G1), the colored ink composition (composition W1), and the aqueous alkaline solution (composition N1 and composition N2) obtained through the above preparation.
Printing machine: a machine modified from SC-F2200 (manufactured by Seiko Epson Corporation)
Drying: The fabric was dried under a condition of 160° C. and 3 minutes in a belt conveyor oven (Fusion R 36-6-4 manufactured by M&R).
Fabric: a 100% cotton black T-shirt (Printstar) having a value of L^{*} of 12 in a colored portion

### Application Condition

Image resolution: 1200×600 dpi
Driving Duty of each array: 100%
Carriage (CR) moving speed: 6 to 40 inch/s
Head driving frequency: 3 to 60 kHz
Application amount adjustment: adjusted using the CR moving speed and the driving frequency
Printed image pattern (solid pattern): (1 inch×10 inch)

The head nozzle configuration shown in FIG. 2 is used. The arrays A and B are used as the nozzle array for ejecting the reactive liquid. The arrays C and D are used as the nozzle array for ejecting the clear ink composition. The arrays E to H are used as the nozzle array for ejecting the colored ink composition. The arrays A′ and B′ are used as the nozzle array for ejecting the aqueous alkaline solution.

In Tables 2 and 3, (1) to (3) in “printing order” are the following orders.

(1):

In the first scanning, the reactive liquid and the clear ink composition are applied to the same region of the fabric in the same scanning.

In the second scanning, the reactive liquid and the colored ink composition are applied to the region of the fabric to which the clear ink composition is applied, in the same scanning.

In the third scanning, the aqueous alkaline solution is applied to the region of the fabric to which the colored ink composition is applied.

(2):

In the first scanning, the reactive liquid and the clear ink composition are applied to the same region of the fabric in the same scanning.

In the second scanning, the colored ink composition is applied to the region of the fabric to which the clear ink composition is applied.

In the third scanning, the aqueous alkaline solution is applied to the region of the fabric to which the colored ink composition is applied.

(3):

In the first scanning, the reactive liquid, the clear ink composition, and the colored ink composition are applied to the same region of the fabric in the same scanning.

In the second scanning, the aqueous alkaline solution is applied to the region of the fabric to which the colored ink composition is applied.

An application weight of the reactive liquid in Tables 2 and 3 is the total amount of the reactive liquid applied in the first scanning and the second scanning when printing order (1) is used.

### 2.3 Evaluation Method

### 2.3.1 Color Developing Property

The color developing property (whiteness) of the above obtained recorded matter is determined in accordance with the following criteria by measuring the value of L^{*} (whiteness) using a fluorescent spectrodensitometer (FD-7 manufactured by Konica Minolta, Inc.).
Determination Criteria
AA: L^{*} of 85 [−] or more
A: L^{*} of 74-84 [−]
B: L^{*} of 65-74 [−]
C: L^{*} less than 65 [−]

### 2.3.2 Image Cracking

The printed image on the above obtained recorded matter is observed under a digital microscope (VHX-5000, Keyence) to identify the number of cracks in a 1-inch square of the ink coating. Image (white ink layer) cracking is determined in accordance with the following criteria.
Determination Criteria
A: no cracks in the ink coating (1 inch×1 inch)
B: four or fewer cracks in the ink coating (1 inch×1 inch)
C: five or more cracks in the ink coating (1 inch×1 inch)

### 2.3.3 Ink Bleeding

A boundary portion between a printed portion and a non-printed portion of the above obtained recorded matter is observed under a digital microscope (VHX-5000, Keyence). When bleeding of the colored ink into the non-printed portion is identified, a distance in a direction perpendicular to the boundary is measured. Ink (white ink) bleeding is determined in accordance with the following criteria. Determination is performed in units of 1 mm, and fractional parts are rounded up. When bleeding is 1 mm or less, it is determined that bleeding is not present.
Determination Criteria
A: No bleeding into the non-printed portion
B: Bleeding of 2 mm to 4 mm into the non-printed portion
C: Bleeding of 5 mm or more into the non-printed portion

### 2.4 Evaluation Result

An evaluation result is shown in Tables 2 and 3.

From the result according to Tables 2 and 3, any ink jet recording method according to each example including the acidic reactive liquid application step of applying the acidic reactive liquid containing the acid and the water to the fabric using the ink jet method, the anionic clear ink application step of applying the anionic clear ink composition containing the first anionic resin particle and the water to the fabric using the ink jet method, the anionic colored ink application step of applying the anionic colored ink composition containing the pigment, the second anionic resin particle, and the water to the region to which the clear ink composition is applied, using the ink jet method, and the anionic solution application step of applying the anionic aqueous alkaline solution having a pH greater than 8.0 to the region to which the colored ink composition is applied is favorable in reducing image cracking and reducing ink bleeding.

Meanwhile, the ink jet recording method according to each comparative examples not satisfying the above configuration is not favorable in at least one of reducing image cracking and reducing ink bleeding.

The following contents are derived from the above embodiment.

According to an aspect of an ink jet recording method, the ink jet recording method includes an acidic reactive liquid application step of applying an acidic reactive liquid containing an acid and water to a fabric using an ink jet method, an anionic clear ink application step of applying an anionic clear ink composition containing a first anionic resin particle and water to the fabric using the ink jet method, an anionic colored ink application step of applying an anionic colored ink composition containing a pigment, a second anionic resin particle, and water to a region to which the clear ink composition is applied, using the ink jet method, and an anionic solution application step of applying an anionic aqueous alkaline solution having a pH greater than 8.0 to a region to which the colored ink composition is applied.

In the aspect of the ink jet recording method, an application amount (X) of the reactive liquid applied to the fabric per unit area in the acidic reactive liquid application step, a neutralizing power conversion value (Y) of the clear ink composition applied to the fabric for the reactive liquid in the anionic clear ink application step, and a neutralizing power conversion value (Z) of the colored ink composition applied to the fabric for the reactive liquid in the anionic colored ink application step may satisfy the following relational expression.

$$X - ( Y + Z ) \geq 0 \qquad Expression ( 1 )$$

In any aspect of the ink jet recording method, the X, the Y, the Z, and a neutralizing power conversion value (W) of the aqueous alkaline solution applied to the region to which the colored ink composition is applied, for the reactive liquid in the anionic solution application step may satisfy the following relational expression.

$$W \geq X - ( Y + Z ) \qquad Expression ( 2 )$$

In any aspect of the ink jet recording method, the acid may be a compound including one to three carboxyl groups.

In any aspect of the ink jet recording method, the aqueous alkaline solution may contain one or more selected from the anionic resin particle, an inorganic alkali, and an organic alkali as an alkaline component.

In any aspect of the ink jet recording method, the anionic solution application step may be performed using the ink jet method.

The ink jet recording method of any aspect may further include a drying step after the anionic solution application step.

In any aspect of the ink jet recording method, a pH of the aqueous alkaline solution may be 11.0 or less.

The present disclosure is not limited to the above embodiment, and various modifications can be made. For example, the present disclosure includes substantially the same configurations as the configurations described in the embodiment, such as configurations having the same function, method, and result or configurations having the same object and effect. The present disclosure also includes configurations obtained by replacing non-essential parts of the configurations described in the embodiment. The present disclosure also includes configurations achieving the same action and effect or configurations that can achieve the same object as the configurations described in the embodiment. The present disclosure also includes configurations obtained by adding a well-known technology to the configurations described in the embodiment.

What is claimed is:

1. An ink jet recording method comprising:
an acidic reactive liquid application step of applying an acidic reactive liquid containing an acid and water to a fabric using an ink jet method;
an anionic clear ink application step of applying an anionic clear ink composition containing a first anionic resin particle and water to the fabric using the ink jet method;
an anionic colored ink application step of applying an anionic colored ink composition containing a pigment, a second anionic resin particle, and water to a region to which the clear ink composition is applied, using the ink jet method; and
an anionic solution application step of applying an anionic aqueous alkaline solution having a pH greater than 8.0 to a region to which the colored ink composition is applied.

2. The ink jet recording method according to claim 1, wherein
an application amount (X) of the reactive liquid applied to the fabric per unit area in the acidic reactive liquid application step,
a neutralizing power conversion value (Y) of the clear ink composition applied to the fabric for the reactive liquid in the anionic clear ink application step, and
a neutralizing power conversion value (Z) of the colored ink composition applied to the fabric for the reactive liquid in the anionic colored ink application step satisfy the following relational expression:
$$X - ( Y + Z ) \geq 0. \qquad Expression ( 1 )$$

3. The ink jet recording method according to claim 2, wherein
the X, the Y, the Z, and
a neutralizing power conversion value (W) of the aqueous alkaline solution applied to the region to which the colored ink composition is applied, for the reactive liquid in the anionic solution application step satisfy the following relational expression:
$$W \geq X - ( Y + Z ) . \qquad Expression ( 2 )$$

4. The ink jet recording method according to claim 1, wherein
the acid is a compound including one to three carboxyl groups.

5. The ink jet recording method according to claim 1, wherein
the aqueous alkaline solution contains one or more selected from the anionic resin particle, an inorganic alkali, and an organic alkali as an alkaline component.

6. The ink jet recording method according to claim 1, wherein
the anionic solution application step is performed using the ink jet method.

7. The ink jet recording method according to claim 1, further comprising:
a drying step after the anionic solution application step.

8. The ink jet recording method according to claim 1, wherein
a pH of the aqueous alkaline solution is 11.0 or less.
